(19) United States
(12) Patent Application Publication
(10) Pub. No.: US 2020/0035169 A1
(43) Pub. Date: Jan. 30, 2020

(54) DISPLAY DEVICE AND DRIVING METHOD THEREOF

(71) Applicant: Sharp Kabushiki Kaisha, Sakai City, Osaka (JP)

(72) Inventor: Tamotsu SAKAI, Sakai City (JP)

(21) Appl. No.: 16/493,805

(22) PCT Filed: Mar. 28, 2017
(86) PCT No.: PCT/JP2017/012560

§ 371 Date: Sep. 13, 2019

(51) Int. Cl. G09G 3/3291; G09G 3/3233

(52) U.S. Cl. CPC G09G 3/3291; G09G 2300/0852; G09G 3/3233

(57) ABSTRACT

Provided is a display device employing an SSD method and capable of suppressing the occurrence of uneven luminance and providing high image quality display, and also provided is a method for driving the same.

A data signal that is to be supplied through a data output line d₁ during one scanning period is either an R or G data signal, and the other data signal is not supplied. Accordingly, the data signal that is not supplied during that one scanning period is supplied during an immediately preceding scanning period and held in a data capacitor, and such data signals that are being held are simultaneously written to corresponding pixels. As a result, it is possible to ensure sufficient writing time for writing R, G, and B data signals respectively to R, G, and B pixels during the one scanning period, thereby eliminating the risk of the data signals not being written correctly due to the shortage of writing time.

### TECHNICAL FIELD

The following disclosure relates to display devices and methods for driving the same, more specifically to a display device, such as an organic EL display device, which includes electro-optical elements driven by current, and also to a method for driving the same.

### BACKGROUND ART

Organic EL (electroluminescent) display devices have been drawing attention as display devices characterized by, for example, being thin and achieving high image quality and low power consumption, and such organic EL display devices are now actively being developed. One known method for driving such an organic EL display device is a method called SSD (source shared driving; hereinafter, an “SSD method”). Accordingly, an organic EL display device employing an SSD method will be described below.

FIG. 16 is a block diagram illustrating the configuration of an organic EL display device described in Patent Document 1. As shown in FIG. 16, a display portion 10 is provided with n scanning lines S₁ to Sₙ and n emission lines E₁ to Eₙ, as well as (3×m) data lines Dᵣ₁ to Dᵣₘ, D_{g1} to D_{gm}, and D_{b1} to D_{bm} disposed crossing these lines. Moreover, the display portion 10 has (3×m×n) pixel circuits 11ᵣ to 11_{b} respectively provided near intersections of the data lines and the scanning lines. The pixel circuits emit light corresponding to R, G, and B data signals supplied through the data lines Dᵣ₁ to Dᵣₘ, D_{g1} to D_{gm}, and D_{b1} to D_{bm}, whereby the display portion 10 displays an image.

A data line driver 30 generates R, G, and B data signals in accordance with data and a control signal SC1 provided by a display control circuit 20, and, for each horizontal period, supplies the data signals for one horizontal line respectively to the data lines Dᵣ₁ to Dᵣₘ, D_{g1} to D_{gm}, and D_{b1} to D_{bm}. A scanning line driver 50 generates scanning signals in accordance with a control signal SC2 provided by the display control circuit 20, and supplies the generated signals sequentially to the scanning lines S₁ to Sₙ. As a result, pixels connected to the scanning lines provided with the scanning signals are sequentially selected.

FIG. 17 is a diagram illustrating the configuration of a demultiplexer 401 included in a demultiplexing portion 40 shown in FIG. 16. As shown in FIG. 17, the demultiplexer 401 includes three selection transistors Mᵣ, M_{q}, and M_{b}. These selection transistors Mᵣ, M_{g}, and M_{b} have gate terminals respectively connected to data control lines ASWᵣ, ASW_{g}, and ASW_{b}. Moreover, once the selection transistors Mᵣ, M_{g}, and M_{b} are rendered in ON state, the selection transistors Mᵣ, M_{g}, and M_{b} connect the respective data lines Dᵣ₁,D_{g1}, and D_{b1} to a data output line d₁. For example, the selection transistor Mᵣ is rendered in ON state by being provided with a data control signal SSDᵣ, and supplies the data line Dᵣ₁ with an R data signal supplied through the data output line d₁. As a result, the R data signal supplied to the data line Dᵣ₁ is held in a data capacitor Cdᵣ₁. Similarly, a G data signal supplied through the data output line d₁ is held in a data capacitor Cd_{g1}, and a B data signal supplied through the data output line d₁ is held in a data capacitor Cd_{b1}. By using the demultiplexer in this manner, it is rendered possible to reduce the number of output terminals of the data line driver 30, thereby reducing the cost of producing the data line driver 30.

FIG. 18 is a timing chart describing a drive method for the organic EL display device shown in FIG. 16. While the following description is directed to a method for driving the demultiplexer 401, other demultiplexers are also driven in the same manner. In the timing chart shown in FIG. 18, during a first-row scanning period, the data line Dᵣ₁ is supplied with a data signal R₁, and the data signal R₁ is held in the data capacitor Cdᵣ₁. Then, the data line D_{g1} is supplied with a data signal G₁, and the data signal G₁ is held in the data capacitor Cd_{g1}. Moreover, the data line D_{b1} supplied with a data signal B₁, and the data signal B₁ is held in the data capacitor Cd_{b1}. Thereafter, the scanning line S₁ is provided with a low-level scanning signal Scan₁. As a result, the data signals R₁, G₁, and B₁ respectively held in the data capacitors Cdᵣ₁, Cd_{g1}, and Cd_{b1} are simultaneously written to pixels r₁, g₁, and b₁.

Similarly, during a second-row scanning period, the data lines Dᵣ₁ and D_{g1} are respectively supplied with data signals R₂ and G₂. Moreover, simultaneously with the data line D_{b1} being supplied with a data signal B₂, the scanning line S₂ is provided with a low-level scanning signal Scan₂. As a result, the data signals R₂, G₂, and B₂ are simultaneously written to pixels r₂, g₂, and b₂. Note that among the periods that represent the statuses of the scanning lines S₁ to S₅ in FIG. 18, periods shown as filled represent periods during which the scanning lines are provided with low-level scanning signals, and will also be referred to by phrases such as “the scanning lines are active” or “the scanning lines are being selected”. The same applies to other timing charts.

FIG. 19 is a timing chart describing another drive method for the organic EL display device shown in FIG. 16. The first-row scanning period, as shown in FIG. 19, will be described first. Initially, a data control signal SSDᵣ being applied to the data control line ASWᵣ, becomes low level, whereby the selection transistor Mr is rendered in ON state. As a result, the data signal R₁ is supplied to the data line Dᵣ₁ and held in the data capacitor Cdᵣ₁. Then, a data control signal SSD_{g} being applied to the data control line ASW_{g} becomes low level, whereby the selection transistor M_{g} is rendered in ON state. As a result, the data signal G₁ is supplied to the data line D_{g1} and held in the data capacitor Cd_{g1}. Moreover, a data control signal SSD_{b} being applied to the data control line ASW_{b} becomes low level, whereby the selection transistor M_{b} is rendered in ON state. As a result, the data signal B₁ is supplied to the data line D_{b1} and held in the data capacitor Cd_{b1}. Simultaneously with this, the scanning signal Scan₁ being provided to the scanning line S₁ is set to low level. Accordingly, the data signals R₁, G₁, and B₁ respectively being held in the data capacitors Cdᵣ₁, Cd_{g1}, and Cd_{b1} are simultaneously written to the pixels r₁, g₁, and b₁ in the first row.

Similarly, during the second-row scanning period, the selection transistor M_{b} is rendered in ON state, and simultaneously with the data signal B₂ being supplied to the data line D_{b2}, the scanning signal Scan₂ being provided to the scanning line S₂ is set to low level. As a result, the data signals R₂, G₂, and B₂ being respectively held in the data capacitors Cdᵣ₁, Cd_{g1}, and Cd_{b1} are simultaneously written to the pixels r₂, g₂, and b₂ in the second row. Thereafter, the writing of data signals will be similarly repeated until data signals Rₙ, Gₙ, and Bₙ are respectively written to pixels rₙ, gₙ, and bₙ in the n'th row.

### CITATION LIST

### Patent Document

Patent Document 1: Japanese Laid-Open Patent Publication No. 2007-79580

### SUMMARY OF THE INVENTION

### Problems to Be Solved By the Invention

In the drive method shown in FIG. 18, the R, G, and B data signals are sequentially supplied to the data lines Dᵣ₁, D_{g1}, and D_{b1}. In addition, after the B data signal is supplied to the data line D_{b1}, the scanning signal Scan₁ being provided to the scanning line S₁ becomes low level, and simultaneous writing of the data signals to the respectively corresponding pixels r₁, g₁, and b₁ is started. In this manner, in the organic EL display device disclosed in Patent Document 1, the R, G, and B data signals are sequentially supplied to the respective data lines Dᵣ₁, D_{g1}, and D_{b1}, and after the supply, a writing period is started to write the data signals to the respective pixels r₁, g₁, and b₁ through the data lines Dᵣ₁, D_{g1}, D_{g1}, and D_{b1}.

Accordingly, the higher the definition of the image that is to be displayed becomes, the more difficult it becomes to ensure sufficient writing time. If sufficient writing time cannot be ensured, there arise such problems as a decrease in display image resolution and noticeably uneven luminance due to threshold voltage variations among drive transistors included in pixel circuits which serve as pixels.

Furthermore, in the drive method shown in FIG. 19, the period during which the B data signal is supplied to the data line D_{b1} coincides with the period during which the data signals are respectively written to the pixels r₁, g₁, and b₁, and therefore, writing time that can be ensured is longer than in the case shown in FIG. 18. However, in this case also, for each horizontal period, it is necessary to supply the data signals respectively to the three data lines Dᵣ₁, D_{g1}, and D_{b1} via the three selection transistors Mᵣ, M_{g}, and M_{b} included in the demultiplexer 401, and therefore, sufficient writing time might not always be ensured. Accordingly, in the case where a high-definition image is displayed, the writing time might still be insufficient, resulting in the aforementioned problems.

Therefore, it is desired to provide a display device employing an SSD method and capable of suppressing the occurrence of uneven luminance and providing high image quality display, and also desired to provide a method for driving the same.

### Solution to the Problems

A first aspect of the present invention is directed to a method for driving an active-matrix display device for displaying a color image based on a plurality of colors by supplying pixel circuits with a plurality of data signals in a time division manner, the data signals respectively corresponding to the colors, the display device including:

a plurality of data lines to be supplied with data signals;

a plurality of scanning lines to be sequentially supplied with scanning signals for selecting the pixel circuits;

a plurality of pixel circuits provided corresponding to the data lines and the scanning lines, each pixel circuit corresponding to any one of the colors;

a scanning line driver circuit configured to sequentially select the scanning lines;

a plurality of select/output circuits configured to sequentially supply the data signals to the data lines, each data signal corresponding to any one of the colors; and

a data line driver circuit configured to supply the data signals respectively to the select/output circuits, wherein,

each of the pixel circuits corresponding to the colors includes:

an electro-optical element;

a drive transistor configured to control a current flowing through the electro-optical element and having a control terminal and a first conductive terminal electrically connected to each other when the scanning line is being selected; and

a capacitive storage element configured to hold a potential applied at a node connecting the control terminal and the first conductive terminal of the drive transistor,

the select/output circuit supplies the data lines with respectively corresponding data signals representing at least one of the colors, and

the scanning line driver circuit sequentially drives the scanning lines and thereby supplies data signals to the nodes provided in the pixel circuits corresponding to the colors represented by the data signals, with the result that potentials applied at the nodes are held in the capacitive storage elements, the data signals including the data signals representing the at least one of the colors and data signals previously supplied to the data lines and representing a color not represented by the data signals representing the at least one of the colors.

An eleventh aspect of the present invention is directed to a method for driving a display device providing color display based on a plurality of colors by supplying data signals to pixel circuits in a time division manner, each data signal corresponding to any one of the colors,

the display device includes a plurality of data lines to be supplied with data signals, a plurality of scanning lines, a plurality of pixel circuits provided corresponding to the data lines and the scanning lines, each pixel circuit corresponding to any one of the colors, and a plurality of select/output circuits configured to sequentially supply the data signals to the data lines, each data signal corresponding to any one of the colors,

each of the pixel circuits corresponding to the colors includes an electro-optical element, a drive transistor configured to control a current flowing through the electro-optical element and having a control terminal and a first conductive terminal electrically connected to each other when a corresponding scanning line is being selected, and a capacitive storage element configured to hold a potential applied at a node connecting the control terminal and the first conductive terminal of the drive transistor, and

the method including the steps of:
supplying the data lines with respectively corresponding data signals representing at least one of the colors;
sequentially driving the scanning lines and thereby supplying data signals to the nodes provided in the pixel circuits corresponding to the colors represented by the data signals, the data signals including the data signals representing the at least one of the colors and data signals previously supplied to the data lines and representing a color not represented by the data signals representing the at least one of the colors; and
causing the capacitive storage elements to hold the potentials applied at the nodes.

### Effect of the Invention

In the first aspect, in the display device employing an SSD method, data signals representing at least one of the colors and data signals previously supplied to the data lines and representing a color not represented by the data signals representing the at least one of the colors are outputted by the select/output circuit and supplied to nodes provided in pixel circuits corresponding to the respective colors. Accordingly, it is possible to ensure sufficient writing time for writing both the data signals that correspond to the at least one of the colors and the data signals that correspond to the other color(s) to respectively corresponding pixel circuits during the same scanning period, thereby eliminating the risk of the data signals not being written correctly due to the shortage of writing time. Thus, it is possible to suppress the occurrence of uneven luminance due to threshold voltage variations and write data signals correctly to all pixels, whereby the display device can display a high-definition image.

The eleventh aspect renders it possible to achieve effects similar to those achieved by the first aspect.

### BRIEF DESCRIPTION OF THE DRAWINGS

FIG. 1 is a block diagram illustrating the configuration of a display device according to a first embodiment.

FIG. 2 is a circuit diagram illustrating the connection relationship between demultiplexers included in the display device shown in FIG. 1 and R, G, and B pixel circuits connected to the demultiplexers.

FIG. 3 is a diagram illustrating the configuration of R and G pixel circuits included in the display device shown in FIG. 1 and connected to one demultiplexer.

FIG. 4 is a timing chart describing a drive method in which R, G, and B data signals are respectively written to R, G, and B pixels respectively connected to R, G, and B data lines in the display device shown in FIG. 2.

FIG. 5 is a diagram showing data signals written to pixels connected to two demultiplexers in accordance with the drive method described in FIG. 4.

FIG. 6 is a block diagram illustrating the configuration of a display device according to a second embodiment.

FIG. 7 is a circuit diagram illustrating the connection relationship between a demultiplexer included in a demultiplexing portion of the display device shown in FIG. 6 and R, G, and B pixels connected to the demultiplexer.

FIG. 8 is a circuit diagram illustrating the configuration of R, G, and B pixel circuits included in the display device shown in FIG. 6 and connected to one demultiplexer.

FIG. 9 is a timing chart describing a drive method in which R, G, and B data signals are respectively written to R, G, and B pixels respectively connected to R, G, and B data lines in the circuit diagram shown in FIG. 7.

FIG. 10 is a diagram showing data signals written to pixels connected to one demultiplexer in accordance with the drive method described in FIG. 9.

FIG. 11 is a timing chart describing a method in which R, G, and B data signals are respectively written to R, G, and B pixels respectively connected to R, G, and B data lines in a display device according to a third embodiment.

FIG. 12 is a diagram showing data signals written to pixels connected to two demultiplexers in accordance with the drive method described in FIG. 11.

FIG. 13 is a circuit diagram illustrating the connection relationship between a demultiplexer and R, G, and B pixels connected to the demultiplexer in a fourth embodiment.

FIG. 14 is a timing chart describing a drive method in which R, G, and B data signals are respectively written to R, G, and B pixels respectively connected to R, G, and B data lines in the circuit diagram shown in FIG. 13.

FIG. 15 is a diagram showing data signals written to pixels connected to one demultiplexer in accordance with the drive method shown in FIG. 14.

FIG. 16 is a block diagram illustrating the configuration of a display device described in Patent Document 1.

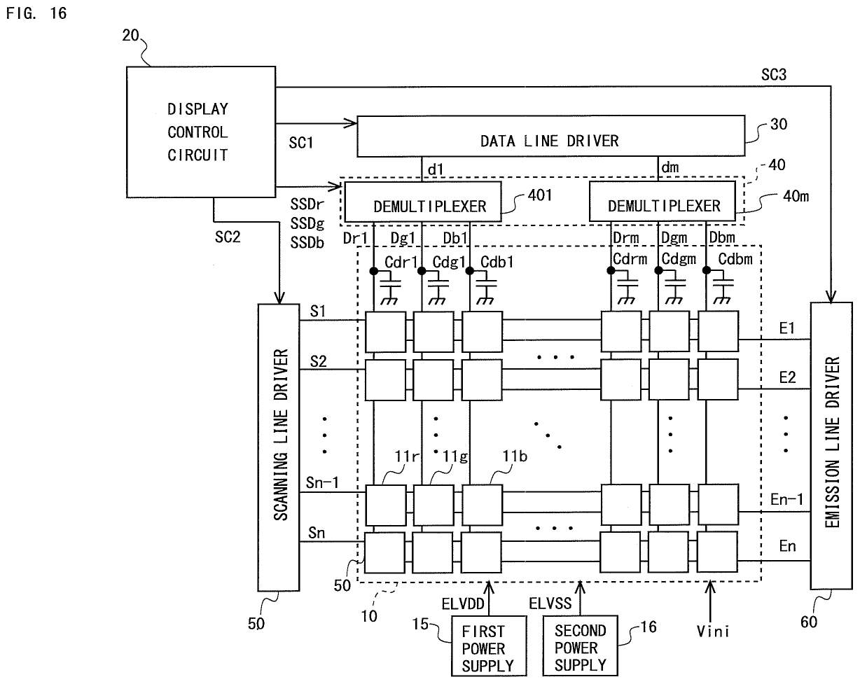

FIG. 17 is a diagram illustrating the configuration of a demultiplexer included in a demultiplexing portion of the display device shown in FIG. 16.

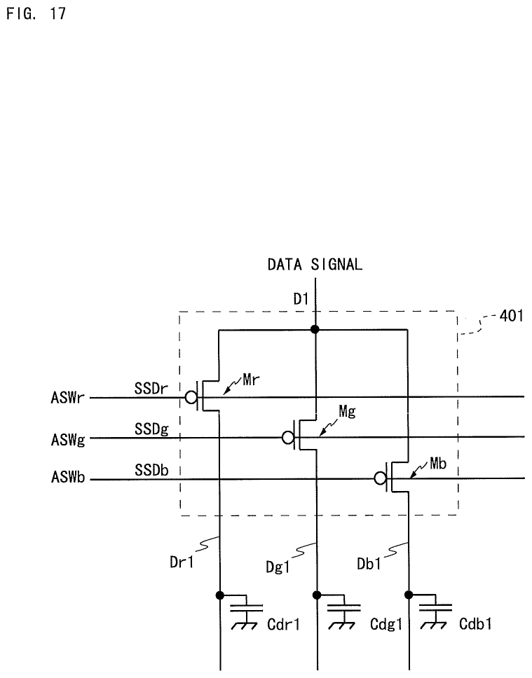

FIG. 18 is a timing chart describing a drive method for the display device shown in FIG. 16.

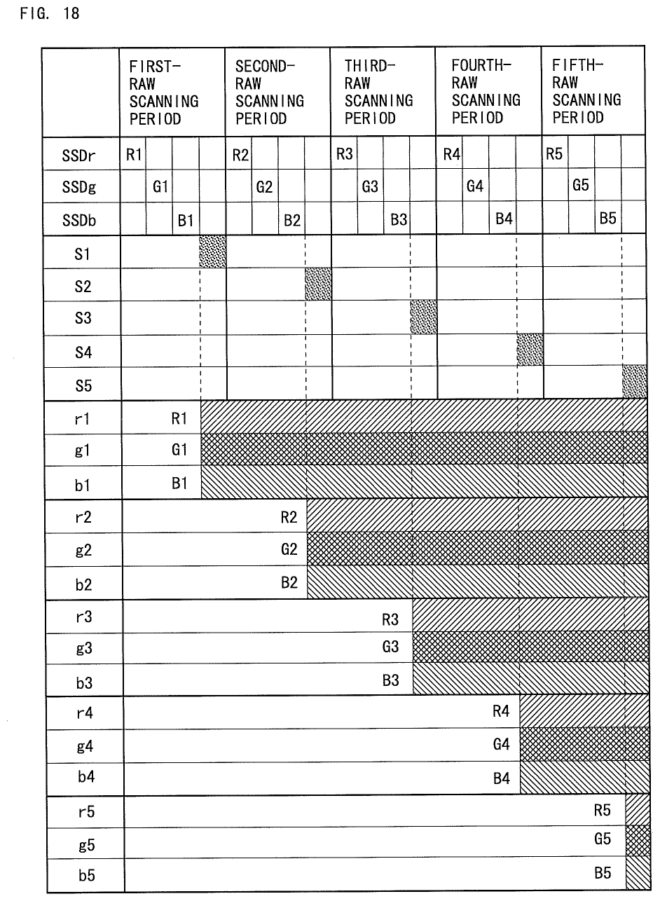

FIG. 19 is a timing chart describing another drive method for the display device shown in FIG. 16.

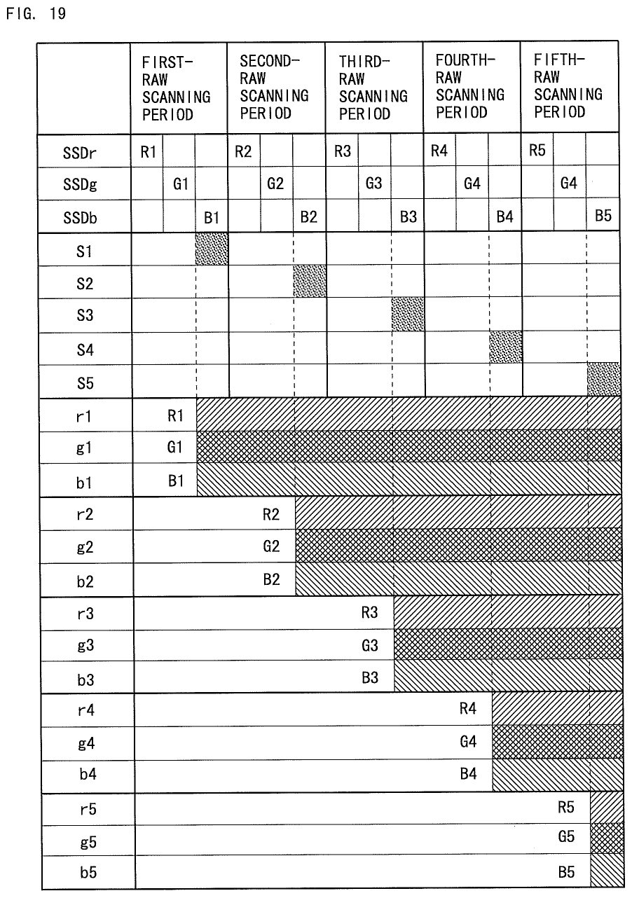

### MODES FOR CARRYING OUT THE INVENTION

Hereinafter, first through fourth embodiments will be described with reference to the accompanying drawings. Note that all transistors in each embodiment will be described as being of P-channel type, but the present invention is not limited to this, and the transistors may be of N-channel type. Moreover, the transistors in each embodiment are, for example, thin-film transistors, but the present invention is not limited to this.

### 1. First Embodiment

<1.1 Configuration of the Organic EL Display Device>

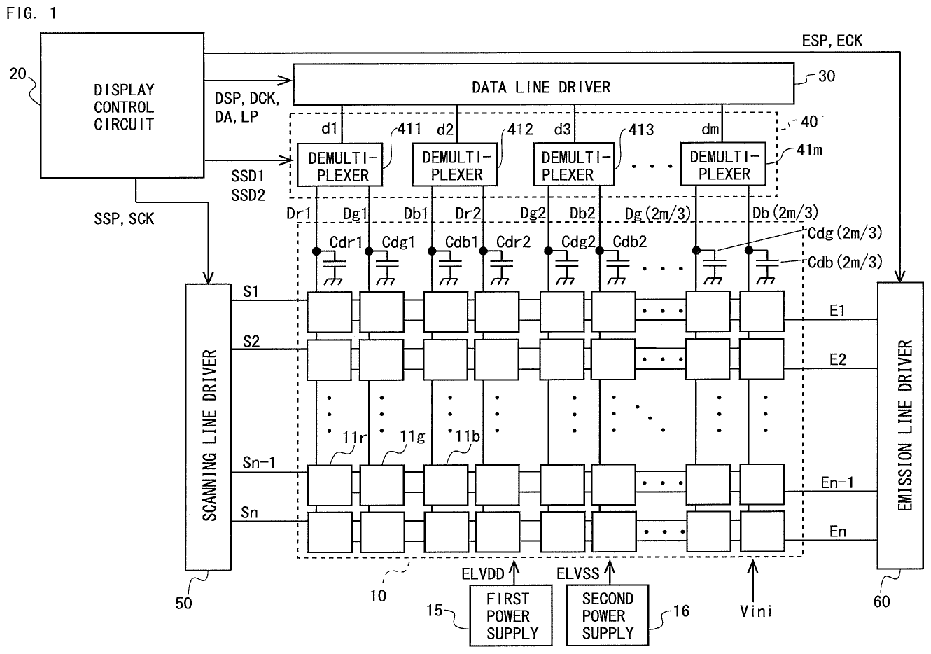

FIG. 1 is a block diagram illustrating the configuration of an organic EL display device according to the first embodiment. The organic EL display device (simply referred to below as the “display device”) is an active-matrix display device capable of color display in the three primary colors, R, G, and B. The display device includes a display portion 10, a display control circuit 20, a data line driver 30, a demultiplexing portion 40, a scanning line driver 50, and an emission line driver 60, as shown in FIG. 1. The display device is a display device employing an SSD method in which the data line driver 30 supplies data signals to data lines via the demultiplexing portion 40. In the present embodiment, the data line driver 30 realizes a data line driver circuit, the scanning line driver 50 realizes a scanning line driver circuit, and the emission line driver 60 realizes a control line driver circuit. The scanning line driver 50 and the emission line driver 60 are, for example, integrally formed with the display portion 10, but the present invention is not limited to this.

The display portion 10 is provided with (m×2) data lines (where m is an integer of 2 or more). More specifically, there are disposed data lines Dᵣ₁ to D_{r(2m/3)}, data lines D_{g1} to D_{g(2m/3)}, and data lines D_{b1} to D_{b(2m/3)}, and further, there are n scanning lines S₁ to Sₙ, disposed perpendicular to these data lines. Moreover, the display portion 10 has pixel circuits provided at respective intersections of the data lines and the scanning lines. More specifically, there are provided (2/3×m×n) pixel circuits 11ᵣ, corresponding to the intersections of the m data lines Dᵣ₁ to Dᵣₘ and the n scanning lines S₁ to Sₙ, also provided (2/3×m×n) pixel circuits 11_{g} corresponding to the intersections of the m data lines D_{g1} to D_{gm} and the n scanning lines S₁ to Sₙ, and further provided (2/3×m×n) pixel circuits 1 1_{b} corresponding to the intersections of the m data lines D_{b1} to D_{bm} and the n scanning lines S₁ to Sₙ. Accordingly, the display portion 10 is provided with a total of (2×m×n) pixel forming portions.

The display portion 10 has n emission lines E₁ to Eₙ serving as control lines disposed parallel to the n scanning lines S₁ to Sₙ. The data lines Dᵣ₁ to D_{r(2m/3)}, D_{g1} to D_{g(2m/3)}, and D_{b1} to D_{b(2m/3)} are connected to the demultiplexing portion 40. The n scanning lines S₁ to Sₙ are connected to the scanning line driver 50. The n emission lines E₁ to Eₙ are connected to the emission line driver 60.

Furthermore, the display portion 10 has power lines (not shown) disposed in common to the pixel circuits 11. More specifically, disposed is the power line that supplies a high-level potential ELVDD for driving organic EL elements (also referred to as “electro-optical elements”) to be described later (the power line will be referred to below as the “high-level power line” and denoted by the same symbol ELVDD as the high-level power source potential), and also disposed is the power line that supplies a low-level potential ELVSS for driving the organic EL elements (the power line will be referred to below as the “low-level power line” and denoted by the same symbol ELVSS as the low-level power source potential). Moreover, there is disposed an initialization line for supplying an initialization potential Vᵢₙᵢ for an initialization operation to be described later (the initialization line will be denoted by the same symbol Vᵥᵢₙᵢ as the initialization potential). These potentials are supplied by a power circuit (not shown). In the present embodiment, the high-level power line ELVDD realizes a first power line, and the low-level power line ELVSS realizes a second power line.

The (2m/3) data lines Dᵣ₁ to D_{r(2m/3)} are respectively connected to (2m/3) data capacitors Cdᵣ₁ to Cd_{r(2m/3)}. The (2m/3) data lines D_{g1} to D_{g(2m/3)} are respectively connected to (2m/3) data capacitors Cd_{g1} to Cd_{g(2m/3)}. The (2m/3) data lines D_{b1} to D_{b(2m/3)} are respectively connected to (2m/3) data capacitors Cd_{b1} to Cd_{b(2m/3)}. Note that each data capacitor is, for example, grounded at one terminal (the terminal that is not connected to the data line), but the present invention is not limited to this. Moreover, the data capacitors Cd_{g}i to Cd_{g1} may include capacitors and parasitic capacitance created by data lines and pixels, or may simply be parasitic capacitance created by data lines and pixels. Note that R, G, and B data capacitors will also be collectively referred to as capacitive storage elements, which include parasitic capacitance.

The display control circuit 20 outputs various control signals to the data line driver 30, the demultiplexing portion 40, the scanning line driver 50, and the emission line driver 60. More specifically, the display control circuit 20 outputs a data start pulse DSP, a data clock DCK, display data DA, and a latch pulse LP to the data line driver 30. The display data DA includes R, G, and B data. The display control circuit 20 also outputs data control signals SSDᵣ, SSD_{g}, and SSD_{b} to the demultiplexing portion 40. The display control circuit 20 also outputs a scanning start pulse SSP and a scanning clock SCK to the scanning line driver 50. The display control circuit 20 further outputs an emission start pulse ESP and an emission clock ECK to the emission line driver 60.

The data line driver 30 includes unillustrated elements, such as an m-bit shift register, a sampling circuit, a latch circuit, and m D/A converters. The shift register has m bistable circuits cascaded together, and transfers the data start pulse DSP supplied to the first stage, in synchronization with the data clock DCK, with the result that a sampling pulse is outputted from each stage. Concurrently with the outputting of the sampling pulse, the sampling circuit is supplied with the display data DA. The sampling circuit memorizes the display data DA in accordance with the sampling pulse. Once the sampling circuit memorizes the display data DA for one row, the display control circuit 20 outputs the latch pulse LP to the latch circuit. Upon reception of the latch pulse LP, the latch circuit holds the display data DA being memorized in the sampling circuit.

The D/A converters are provided corresponding to m data output lines di to dm respectively connected to m output terminals (not shown) of the data driver 30, in order to supply the data output lines d₁ to dₘ with data signals, which are analog signal voltages converted by the D/A converters from the display data DA being held in the latch circuit. Since the display device according to the present embodiment performs color display in the three primary colors, R, G, and B, and employs an SSD method, the R, G, and B data signals are outputted to the data output lines in a time division manner.

The demultiplexing portion 40 includes demultiplexers 41₁ to 41ₘ. For example, the demultiplexer 41₁ has input terminals, each being connected to one data output line d₁. The demultiplexer 41₁ has two output terminals respectively connected to the data lines Dᵣ₁ and D_{g1}. The demultiplexer 41₁ supplies sequentially provided R and G data signals respectively to the data lines Dᵣ₁ and D_{g1} from the two output terminals. Similarly, the demultiplexer 412 supplies sequentially provided B and R data signals respectively to the data lines D_{b1} and Dᵣ₂ from two output terminals. Note that the operation of the demultiplexers 41₁ and 41₂ will be described in detail later.

The scanning line driver 50 drives the n scanning lines S₁ to Sₘ. More specifically, the scanning line driver 50 includes unillustrated elements, such as a shift register and a buffer. The shift register sequentially transfers the scanning start pulse SSP in synchronization with the scanning clock SCK. Scanning signals, which are outputs from stages in the shift register, are supplied to corresponding scanning lines Sⱼ (where j=an integer from 1 to n) via the buffer. By an active scanning signal (in the present embodiment, a low-level signal), (2m/3) pixel circuits 11 connected to the scanning line Sⱼ are collectively selected.

The emission line driver 60 drives the n emission lines E₁ to Eₙ. More specifically, the emission line driver 60 includes unillustrated elements, such as a shift register and a buffer. The shift register sequentially transfers the emission start pulse ESP in synchronization with the emission clock ECK. Emission signals, which are outputs from the stages in the shift register, are supplied to corresponding emission lines Eⱼ (where j=an integer from 1 to n) via the buffer.

As shown in FIG. 1, the scanning line driver 50 is disposed to one side of the display portion 10 (in FIG. 1, to the left of the display portion 10), and the emission line driver 60 is disposed to the other side of the display portion 10 (in FIG. 1, to the right of the display portion 10). In this manner, the drivers are equally disposed on both sides of the display portion 10.

<1.2 Connection Relationship Between the Pixel Circuit and the Data Signal Lines>

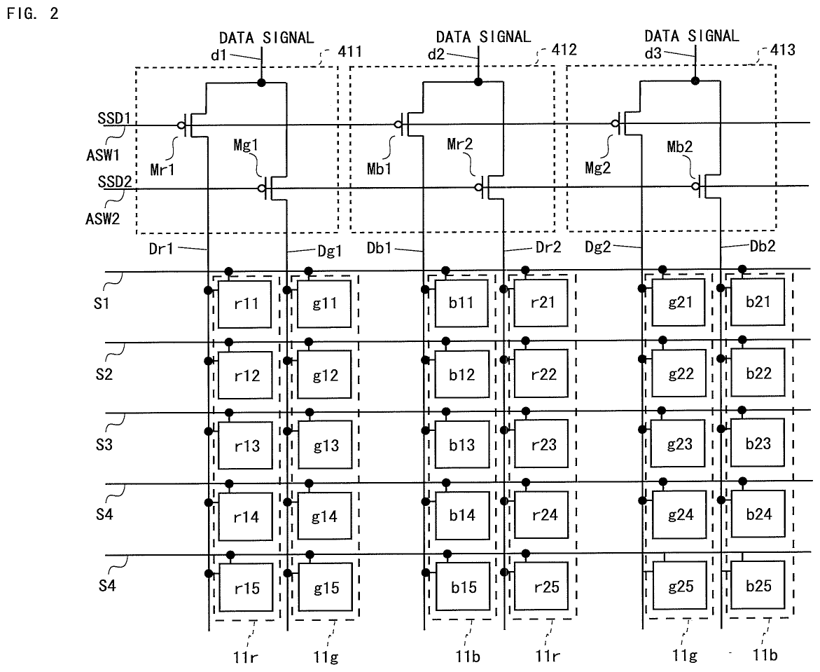

FIG. 2 is a circuit diagram illustrating the connection relationship between each of the demultiplexers 41₁ to 41₃ included in the display device shown in FIG. 1 and different sets of pixel circuits connected to the demultiplexers 41₁ to 41₃, each set consisting of five pixel circuits 11ᵣ, five pixel circuits 11_{g}, or five pixel circuits 11_{b}. Note that in FIG. 2, of the five pixel circuits 11ᵣ, the pixel circuit 11ᵣ that is connected to the scanning line S₁ in the first row is shown as pixel r₁₁ or r₂₁, the pixel circuit 11ᵣ that is connected to the scanning line S₂ in the second row is shown as pixel r₁₂ or r₂₂, the pixel circuit 11ᵣ that is connected to the scanning line S₃ in the third row is shown as pixel r₁₃ or r₂₃, the pixel circuit 11ᵣ that is connected to the scanning line in the fourth row is shown as pixel r₁₄ or r₂₄, and the pixel circuit 11ᵣ that is connected to the scanning line in the fifth row is shown as pixel r₁₅ or r₂₅. Similarly, the pixel circuits 11_{g} are shown as pixels g₁₁ to g₁₅ and g₂₁ to g₂₅, and the pixel circuits 11_{b} as pixels b₁₁ to b₁₅ and b₂₁ to b₂₅. These pixels are disposed in a matrix. Moreover, each pixel is connected to any one of the scanning lines S₁ to S₅.

As shown in FIG. 2, the demultiplexer 41₁ includes selection transistors Mᵣ₁ and M_{g1}, the demultiplexer 41₂ includes selection transistors M_{b1} and Mᵣ₂ and the demultiplexer 413 includes selection transistors M_{g1} and M_{b2}. The selection transistors Mᵣ₁, M_{b1}, and M_{g2} have gate terminals (also referred to as “control terminals”) connected to a data control line ASW₁. The selection transistors M_{g1}, Mᵣ₂, and M_{b2} have gate terminals connected to a data control line ASW₂.

Accordingly, when the data control line ASW₁ is provided with a low-level data control signal SSD₁, the selection transistors Mᵣ₁, M_{b1}, and M_{g2} are rendered in ON state, with the result that the data output line d₁ and the data line Dᵣ₁ are connected via the selection transistor Mᵣ₁, the data output line d₂ and the data line D_{b1} are connected via the selection transistor M_{b1}, and the data output line d₃ and the data line D_{g2} are connected via the selection transistor M_{g2}. Similarly, when the data control line ASW₂ is provided with a low-level data control signal SSD₂, the data output line d₁ and the data line D_{g1} are connected via the selection transistor M_{g1}, the data output line d₂ and the data line Dᵣ₂ are connected via the selection transistor Mᵣ₂, and the data output line d₃ and the data line D_{b2} are connected via the selection transistor M_{b2}.

For convenience of description, the number of pixel circuits 11ᵣ, 11_{g}, or 11_{b} in each set connected to the R, G, and B data lines has been described as five. However, in actuality, the number of pixel circuits 11ᵣ, 11_{g}, or 11_{b} in each set connected to the data lines is n, as shown in FIG. 1.

<1.3 Configuration of the Pixel Circuit>

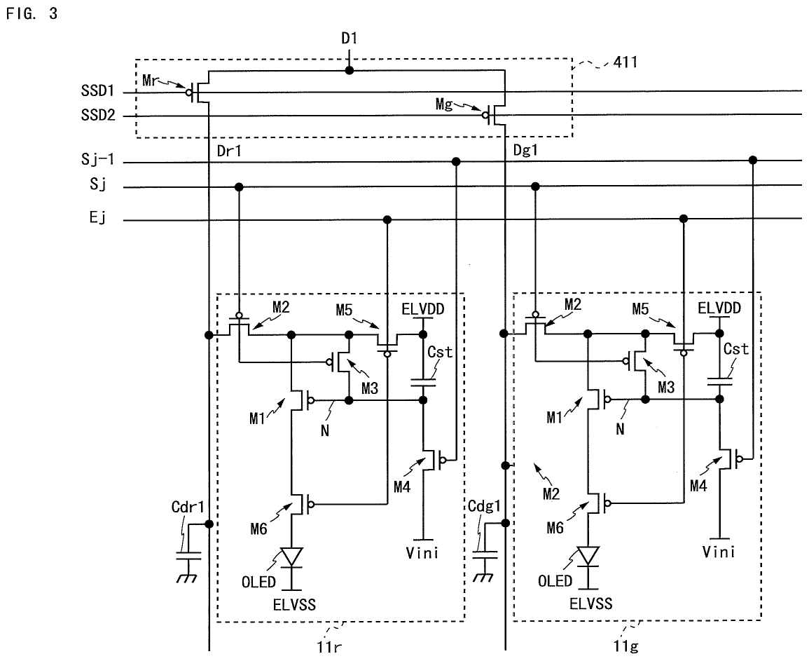

Next, the configuration of the pixel circuit 11 will be described. FIG. 3 is a diagram illustrating the configuration of the pixel circuits 11ᵣ and 11_{g} connected to one demultiplexer 41₁ and respectively serving as the pixels r₁₁ and g₁₁. As shown in FIG. 3, the pixel circuits 11ᵣ and 11_{g} connected to the demultiplexer 41₁ are disposed in this order in a direction in which the scanning line Sⱼ extends. Note that the pixel circuits 11ᵣ and 11_{g} are configured basically in the same manner. Accordingly, in the following, common points between these pixel circuits will be described taking as an example the pixel circuit 11ᵣ, and different points will be described separately as appropriate.

The pixel circuit 11ᵣ includes one organic EL element OLED, six transistors M1 to M6, and one storage capacitor Cₛₜ (also called as a “capacitive storage element”). More specifically, the pixel circuit 11ᵣ includes an organic EL element OLED, a drive transistor M1, a writing transistor M2, a compensation transistor M3, an initialization transistor M4, a power supply transistor M5, an emission control transistor M6, and a storage capacitor Cₛₜ serving as a capacitive element. The drive transistor M1 has a gate terminal, a first conductive terminal, and a second conductive terminal. As for the drive transistor M1, the first and second conductive terminals respectively serve as source and drain terminals, or vice versa, depending on carrier flow. The pixel circuit 11_{g} includes the same elements as those of the pixel circuit 11ᵣ. Note that the first conductive terminal of the drive transistor M1 is a conductive terminal connected to the high-level power line ELVDD via the power supply transistor M5, and the second conductive terminal is a conductive terminal connected to the organic EL element OLED via the emission control transistor M6.

The pixel circuit 11ᵣ is connected to a scanning line Sⱼ (also referred to as a “current scanning line”), a scanning line Sⱼ₋₁ immediately preceding the current scanning line Sⱼ (also referred to as a “previous scanning line”), an emission line Eⱼ, the data line Dᵣ₁, the high-level power line ELVDD, the low-level power line ELVSS, and the initialization line Vᵢₙᵢ. Note that, as described above, the data line Dᵣ₁ is connected to the data capacitor Cdᵣ₁, and the data line D_{g1} is connected to the data capacitor Cd_{g1}.

In the pixel circuit 11ᵣ, the writing transistor M2 has a gate terminal connected to the current scanning line Sⱼ, and a source terminal connected to the data line Dᵣ₁. In the pixel circuit 11ᵣ, when the current scanning line Sⱼ is selected, the writing transistor M2 supplies the first conductive terminal of the drive transistor M1 with an R data signal being held in the data capacitor Cdᵣ₁, and in the pixel circuit 11_{g}, when the current scanning line Sⱼ is selected, the writing transistor M2 supplies the first conductive terminal of the drive transistor M1 with a G data signal being held in the data capacitor Cd_{g1}.

The drive transistor M1 is connected at the first conductive terminal to the drain terminal of the writing transistor M2 and at the gate terminal to a node N. The node N is a node to which a drain terminal of the compensation transistor M3 and a first terminal of the storage capacitor Cₛₜ are connected; a potential at the node N is provided to the gate terminal of the drive transistor M1 as a gate voltage. The drive transistor M1 supplies the organic EL element OLED with a drive current in accordance with the gate voltage.

The compensation transistor M3 is provided between the gate terminal and the second conductive terminal of the drive transistor Ml. The compensation transistor M3 has a gate terminal connected to the current scanning line Sⱼ. When the current scanning line Sⱼ is selected, the compensation transistor M3 connects (or diode-connects) the gate terminal and the second conductive terminal of the drive transistor M1. When the drive transistor M1 is diode-connected, the potential at the node N is set to a gate-to-source voltage V_{gs} lower than the voltage of the data signal by a threshold voltage, and the voltage V_{gs} is applied to the gate terminal of the drive transistor M1.

The initialization transistor M4 is connected between the gate terminal of the drive transistor M1 and the initialization line Vᵢₙᵢ, and has a gate terminal connected to the previous scanning line Sⱼ₋₁. The initialization transistor M4 initializes a gate voltage V_{g} being provided to the gate terminal of the drive transistor M1, upon selection of the previous scanning line Sⱼ₋₁.

The power supply transistor M5 is provided between the high-level power line ELVDD and the first conductive terminal of the drive transistor, and has a gate terminal connected to the emission line Eⱼ. The power supply transistor M5 supplies a high-level potential ELVDD to the drain terminal of the drive transistor M1 upon selection of the emission line Eⱼ.

The emission control transistor M6 is provided between the second conductive terminal of the drive transistor M1 and the organic EL element OLED, and has a gate terminal connected to the emission line Eⱼ. The emission control transistor M6 transmits a drive current to the organic EL element OLED upon selection of the emission line Eⱼ.

The storage capacitor Cₛₜ has the first terminal connected to the gate terminal of the drive transistor M1, and a second terminal connected to the high-level power line ELVDD. The storage capacitor Cₛₜ holds the gate voltage V_{g} being applied to the gate terminal of the drive transistor M1 when the compensation transistor M3 and the initialization transistor M4 of the pixel circuit 11ᵣ are in OFF state.

The organic EL element OLED has an anode (a terminal of the organic EL element OLED) connected to the second conductive terminal of the drive transistor M1 via the emission control transistor M6 and a cathode (the other terminal of the organic EL element OLED) connected to the low-level power line ELVSS. The organic EL element OLED emits light with a luminance in accordance with a drive current. Although not shown in any figures, the configuration of the pixel circuit 11_{b} included in the present embodiment is basically the same as the configuration of the pixel circuits 11ᵣ and 11_{g}, and therefore, any description thereof will be omitted. Note that the configuration of the pixel circuits 11_{b} included in the other demultiplexers 41₂ to 41ₘ is the same as that of the pixel circuits 11ᵣ and 11_{g}, and the configuration of the demultiplexers 41₂ to 41ₘ is the same as that of the demultiplexer 41₁. Accordingly, any descriptions thereof will be omitted.

<1.4 Drive Method>

A drive method in which data signals are written to the pixel circuits 11ᵣ, 11_{g}, and 11_{b} of the display device will be described with respect to the case where, of the three demultiplexers 41₁ to 41₃ shown in FIG. 2, as for the demultiplexer 41₁, R data signals are written to the five pixels r₁₁ to r₁₅ connected to the data line Dᵣ₁ extending therefrom, G data signals are written to the five pixels g₁₁ to g₁₅ connected to the data line D_{g1}, and as for the demultiplexer 41₂, B data signals are written to the five pixels b₁₁ to b₁₅ connected to the data line D_{b1} extending therefrom. Note that the demultiplexer 41₂ is also connected to the pixels r₂₁ to r₂₅, and the pixels r₂₁ to r₂₅ will be described only where necessary for describing the operation of the demultiplexer 41₂.

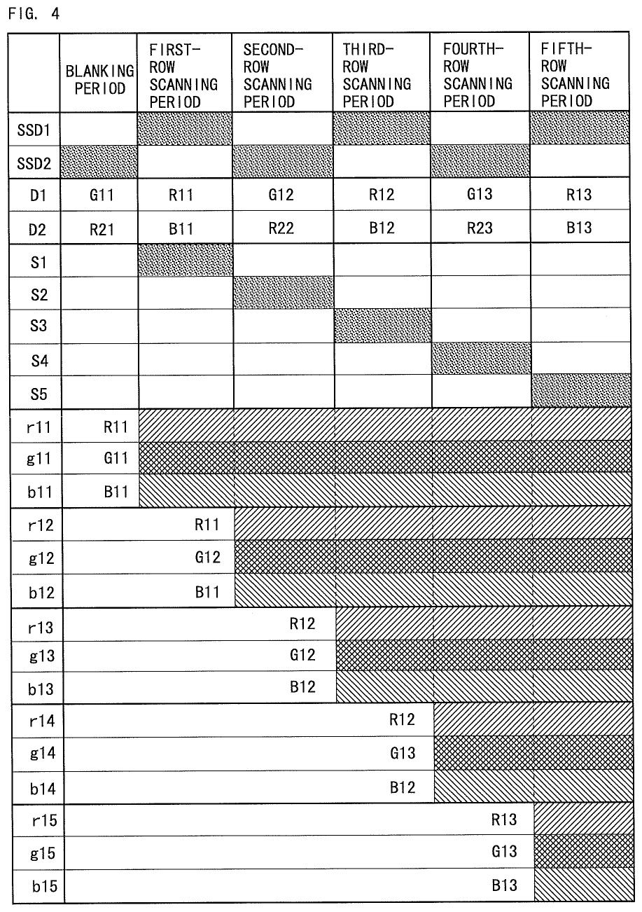

FIG. 4 is a timing chart describing the drive method where R data signals are written to the pixels ru to r₁₅ connected to the data line Dᵣ₁ of the organic EL display device shown in FIG. 2, G data signals are written to the pixels (g₁₁ to g₁₅ connected to the data line D_{g1}, and B data signals are written to the pixels b₁₁ to b₁₅ connected to the data line D_{b1}. As shown in FIG. 4, the data output line d₁ connected to the demultiplexer 41₁ is provided with a data signal D₁ consisting of R and G data signals, and the data output line d₂ connected to the demultiplexer 41₂ is provided with a data signal D₂ consisting of B and R data signals.

Initially, the data output line d₁ is provided with a data signal G₁₁ in the data signal D₁ during a blanking period which starts after data signals are written to the pixels in the n′th row for the previous frame and ends before data signals are written to the pixels in the first row for the current frame. Moreover, the data control line ASW₂ is provided with a low-level data control signal SSD₂. Accordingly, the selection transistor M_{g1} of the demultiplexer 41₁ is rendered in ON state, with the result that the data signal G₁₁ is supplied from the data output line d₁ to the data line D_{g1} and held in the data capacitor Cd_{g1}. Similarly, the selection transistor Mᵣ₂ of the demultiplexer 41₂ is rendered in ON state, with the result that a data signal R₂₁ is supplied from the data output line d₂ to the data line Dᵣ₂ and held in the data capacitor Cdᵣ₁.

Next, during a first-row scanning period, the data output line d₁ is provided with a data signal R₁₁ in the data signal D₁, and the data output line d₂ is provided with a data signal B₁₁ in the data signal D₂. Moreover, the data control line ASW₁ is provided with a low-level data control signal SSD₁. Accordingly, the selection transistor Mᵣ₁ of the demultiplexer 41₁ is rendered in ON state, with the result that the data signal R₁₁ is supplied from the data output line d₁ to the data line Dᵣ₁ and held in the data capacitor Cdᵣ₁. Similarly, the selection transistor M_{b1} of the demultiplexer 41₂ is rendered in ON state, with the result that the data signal B₁₁ is supplied from the data output line d₂ to the data line D_{b1} and held in the data capacitor Cd_{b1}.

Simultaneously, the scanning line S₁ is selected, upon which the data signal R₁₁ supplied to the data line Dᵣ₁ is provided from the data line Dᵣ₁ to the pixel r₁₁, with the result that the node N is provided with a gate-to-source voltage, which is lower than the voltage of the data signal

R₁₁ by a threshold voltage, via the diode connection of the drive transistor M1 and the compensation transistor M3 in the pixel r₁₁, and the gate-to-source voltage is held in the storage capacitor Cₛₜ. The data signal B₁₁ supplied to the data line D_{b1} is provided from the data line D_{b1} to the pixel b₁₁, with the result that the node N is provided with a gate-to-source voltage, which is lower than the voltage of the data signal B₁₁ by a threshold voltage, via the diode connection of the drive transistor M1 and the compensation transistor M3 in the pixel b₁₁, and the gate-to-source voltage is held in the storage capacitor Cₛₜ. The data signal G₁₁ supplied to the data line D_{g1} during the blanking period and being held in the data capacitor Cd_{g1}is provided from the data line D_{g1} to the pixel g₁₁, with the result that the node N is provided with a gate-to-source voltage, which is lower than the voltage of the data signal G₁₁ by a threshold voltage, via the diode connection of the drive transistor M1 and the compensation transistor M3 in the pixel gui, and the gate-to-source voltage is held in the storage capacitor Cₛₜ. In this manner, the data signals R₁₁ and B₁₁ to be respectively written to the pixels ru and b₁₁ are the signals supplied to the data lines Dᵣ₁ and D_{b1} during the first-row scanning period. However, the signal that is used as the data signal G₁₁ to be written to the pixel g₁₁ is the signal supplied to the data line D_{g1} during the immediately preceding blanking period and being held in the data capacitor Cd_{g1}.

Next, during a second-row scanning period, the data output line d₁ is provided with a data signal G₁₂ in the data signal D₁, and the data output line d₂ is provided with a data signal R₂₂ in the data signal D₂. Moreover, the data control line ASW₂ is provided with a low-level data control signal SSD₂. Accordingly, the selection transistor M_{g1} of the demultiplexer 41₁ is rendered in ON state, with the result that the data signal G₁₂ is supplied from the data output line d₁ to the data line D_{g1} and held in the data capacitor Cd_{g1}. Similarly, the selection transistor Mᵣ₂ of the demultiplexer 41₂ is rendered in ON state, with the result that the data signal R₂₂ is supplied from the data output line d₂ to the data line Dᵣ₂ and held in the data capacitor Cdᵣ2.

Simultaneously, the scanning line S₂ is selected, upon which the data signal G₁₂ supplied to the data line D_{g1} is provided from the data line D_{g1} to the pixel g₁₂, with the result that the node N is provided with a gate-to-source voltage, which is lower than the voltage of the data signal G₁₂ by a threshold voltage, via the diode connection of the drive transistor M1 and the compensation transistor M3 in the pixel g₁₂, and the gate-to-source voltage is held in the storage capacitor Cₛₜ. The data signal R₁₁ supplied to the data line Dᵣ₁ during the first-row scanning period and being held in the data capacitor Cdᵣ₁ is provided from the data line Dᵣ₁ to the pixel r₁₂, with the result that the node N is provided with a gate-to-source voltage, which is lower than the voltage of the data signal R₁₁ by a threshold voltage, via the diode connection of the drive transistor M1 and the compensation transistor M3 in the pixel r₁₂, and the gate-to-source voltage is held in the storage capacitor Cₛₜ. The data signal B₁₁ supplied to the data line D_{b1} during the first-row scanning period and being held in the data capacitor Cd_{b1} is provided from the data line D_{b1} to the pixel b₁₂, with the result that the node N is provided with a gate-to-source voltage, which is lower than the voltage of the data signal B₁₁ by a threshold voltage, via the diode connection of the drive transistor M1 and the compensation transistor M3 in the pixel b₁₂, and the gate-to-source voltage is held in the storage capacitor Cₛₜ. In this manner, the data signal G₁₂ to be written to the pixel g₁₂ is the signal supplied to the data line D_{g1} during the second-row scanning period. However, the signals that are used as the data signals R₁₁ and B₁₁ to be respectively written to the pixels r₁₂ and b₁₂ are the signals supplied to the data line Dᵣ₁ during the first-row scanning period.

Next, during a third-row scanning period, the data output line d₁ is provided with a data signal R₁₂ in the data signal D₁, and the data output line d₂ is provided with a data signal B₁₂ in the data signal D₂. Moreover, the data control line ASW₁ is provided with a low-level data control signal SSD₁. Accordingly, the selection transistor Mᵣ₁ of the demultiplexer 41₁ is rendered in ON state, with the result that the data signal R₁₂ is supplied from the data output line d₁ to the data line Dᵣ₁ and held in the data capacitor Cdᵣ₁. Similarly, the selection transistor M_{b1} of the demultiplexer 41₂ is rendered in ON state, with the result that the data signal B₁₂ is supplied from the data output line d₂ to the data line D_{b1} and held in the data capacitor Cd_{b1}. The data signal G₁₂ supplied to the data line D_{g1} and being held in the data capacitor Cd_{g1} is provided from the data line D_{g1} to the node N via the drive transistor M1 in the pixel g₁₃ and held in the storage capacitor Cₛₜ.

Simultaneously, the scanning line S₃ is selected, upon which the data signal R₁₂ supplied to the data line Dᵣ₁ is provided from the data line Dᵣ₁ to the pixel r₁₃, with the result that the node N is provided with a gate-to-source voltage, which is lower than the voltage of the data signal R₁₂ by a threshold voltage, via the diode connection of the drive transistor M1 and the compensation transistor M3 in the pixel r₁₂, and the gate-to-source voltage is held in the storage capacitor Cₛₜ. The data signal B₁₂ supplied to the data line D_{b1} is provided from the data line D_{b1} to the pixel b₁₃, with the result that the node N is provided with a gate-to-source voltage, which is lower than the voltage of the data signal B₁₂ by a threshold voltage, via the diode connection of the drive transistor M1 and the compensation transistor M3 in the pixel b₁₃, and the gate-to-source voltage is held in the storage capacitor Cₛₜ. The data signal G₁₂ supplied to the data line D_{g1} during the second-row scanning period and being held in the data capacitor Cd_{g1} is provided from the data line D_{g1} to the pixel g₁₃, with the result that the node N is provided with a gate-to-source voltage lower than the voltage of the data signal G₁₂ by a threshold voltage, via the diode connection of the drive transistor M1 and the compensation transistor M3 in the pixel g13, and the gate-to-source voltage is held in the storage capacitor Cₛₜ. In this case, the data signals R₁₂ and B₁₂ to be supplied are the signals respectively supplied to the data lines Dᵣ₁ and D_{b1} during the third-row scanning period. However, the signal that is used as the data signal G₁₂ is the signal supplied to the data line D_{g1} during the second-row scanning period. Note that the operations of writing the data signals to the pixels that have been described in detail above will be collectively referred to below by the phrase such as “writing data signals to pixels”.

Thereafter, similarly, during a fourth-row scanning period, the data signal R₁₂ supplied to the data line Dᵣ₁ is written to the pixel r₁₄, a data signal G₁₃ supplied to the data line D_{g1} is written to the pixel g₁₄, and the data signal B₁₂ supplied to the data line D_{b1} is written to the pixel b₁₄. During a fifth-row scanning period, a data signal R₁₃ supplied to the data line Dᵣ₁ is written to the pixel r₁₅, the data signal G₁₃ supplied to the data line D_{g1} is written to the pixel g₁₅, and a data signal B₁₃ supplied to the data line D_{b1} is written to the pixel b₁₅.

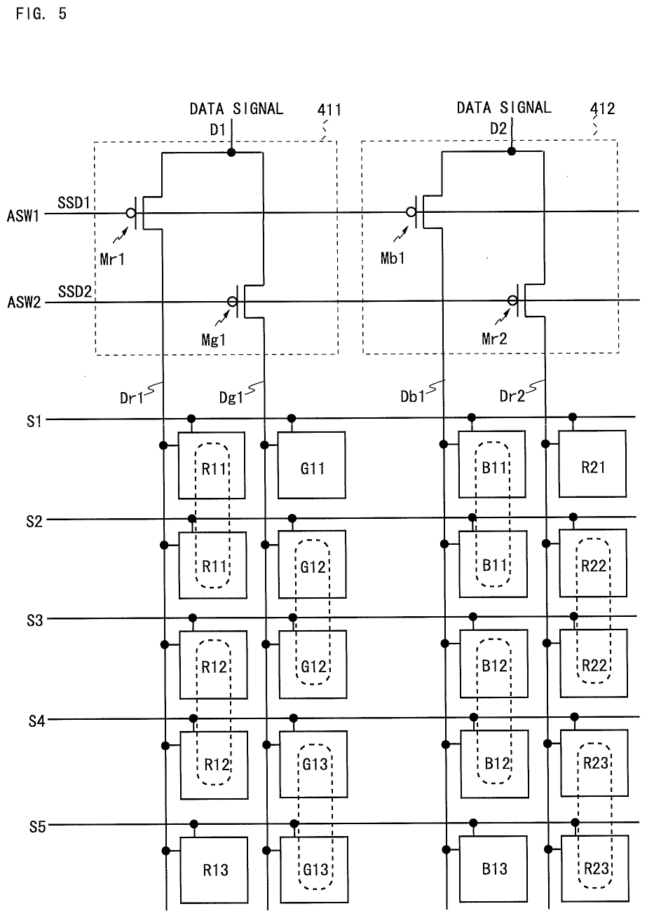

FIG. 5 is a diagram showing data signals written to pixels connected to the demultiplexers 41₁ and 41₂ in accordance with the drive method described in FIG. 4. As shown in FIG. 5, data signals, in order from the scanning line S₁ side: R₁₁, R₁₁, R₁₂, R₁₂, and R₁₃, are sequentially written to five R pixels connected to the data line Dᵣ₁, data signals, in the order: G₁₁, G₁₂, G₁₂, G₁₃, and G₁₃, are sequentially written to five G pixels connected to the data line D_{g1}, and data signals, in the order: B₁₁, B₁₁, B₁₂, B₁₂, and B₁₃, are sequentially written to five pixels connected to the data line D_{b1}. As a result, as for the R pixels, the same data signal R₁₁ is written to the first and second pixels, and the same data signal R₁₂ is written to the third and fourth pixels. As for the G pixels, the same data signal G₁₂ is written to the second and third pixels. As for the B pixels, the same data signal B₁₁ is written to the first and second pixels, and the same data signal B₁₂ is written to the third and fourth pixels. In FIG. 5, of the written data signals, the consecutively written data signals are enclosed by dotted lines.

<1.5 Effects>

In the present embodiment, one or two of the data signals to be written to the R, G, and B pixels during one scanning period are a data signal or data signals that has or have been written to the data line(s) during the previous scanning period and held in the data capacitor(s), and such data signals are utilized and written simultaneously to corresponding pixels. Accordingly, it is possible to ensure sufficient writing time for writing R, G, and B data signals respectively to the R, G, and B pixels during the scanning period, thereby eliminating the risk of the data signals not being written correctly due to the shortage of writing time. Thus, even for a display device with a number of pixels, data signals can be written correctly to all pixels, whereby the display device can display a high-definition image.

### 2. Second Embodiment

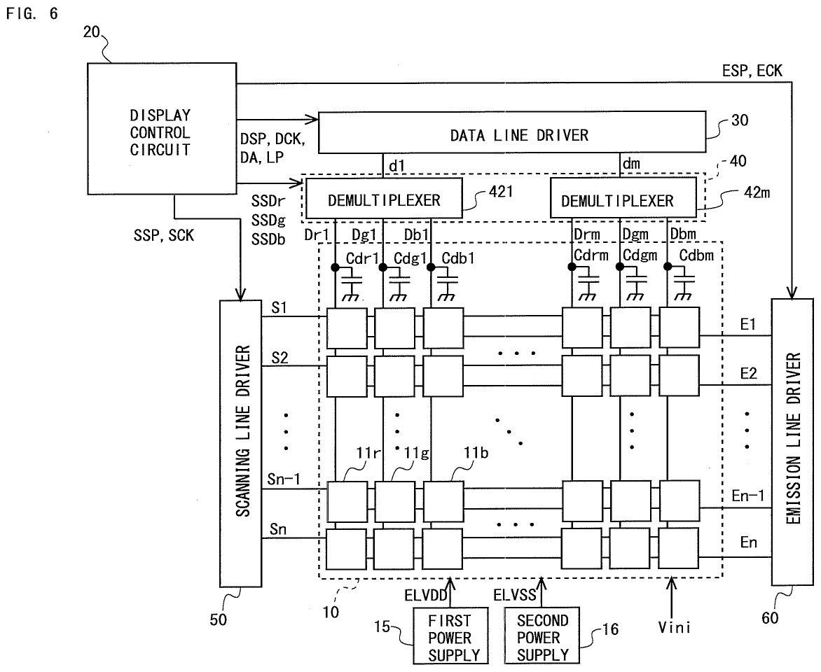

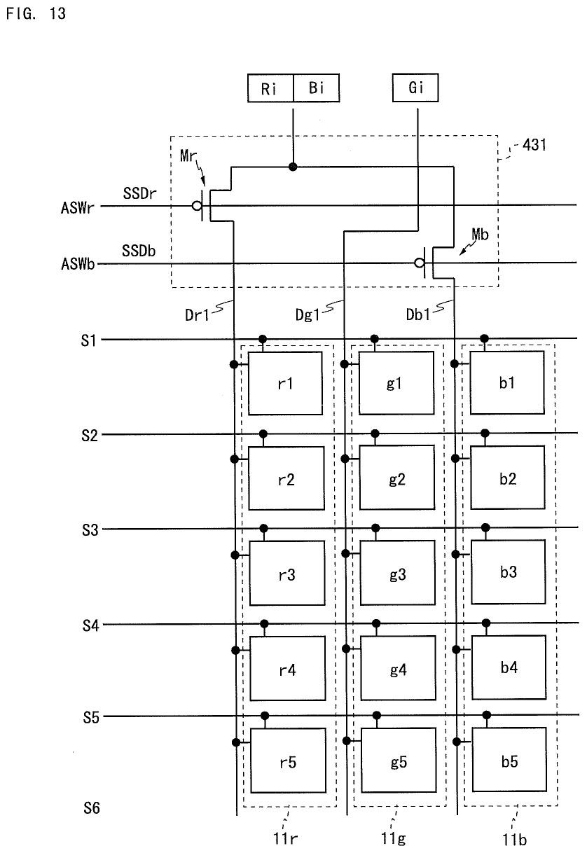

FIG. 6 is a block diagram illustrating the configuration of an organic EL display device according to a second embodiment. As with the display device shown in FIG. 1 and the display device shown in FIG. 13, the display device according to the present embodiment is a display device performing color display in the three primary colors, R, G, and B and employing an SSD method in which the data line driver 30 supplies data signals to data lines via the demultiplexing portion 40. Accordingly, the display device is configured almost in the same manner as the display devices shown in FIGS. 1 and 13. Therefore, the same components as those of the display devices shown in FIGS. 1 and 13 are denoted by the same reference characters, any descriptions thereof will be omitted, and different components will be described.

The display portion 10 is provided with (3×m) data lines (where m is an integer of 2 or more).

Specifically, there are disposed m data lines Dᵣ₁, to Dᵣₘ, m data lines D_{g1} to D_{gm}, and m data lines D_{b1} to D_{bm}. Further, there are n scanning lines S₁ to Sₙ disposed perpendicularly to these data lines. Moreover, there are pixel circuits disposed at respective intersections of the data lines and the scanning lines. More specifically, there are provided (m×n) pixel circuits 11ᵣ corresponding to the intersections of the m data lines Dᵣ₁ to Dᵣₘ and the n scanning lines S₁ to Sₙ, (m×n) pixel circuits 11_{g} corresponding to the intersections of the m data lines D_{g1} to D_{gm} and the n scanning lines S₁ to Sₙ, and (m×n) pixel circuits 11_{b} corresponding to the intersections of the m data lines D_{b1} to D_{bm} and the n scanning lines S₁ to Sₙ.

Furthermore, the display portion 10 has n emission lines E₁ to Eₙ serving as control lines disposed parallel to the n scanning lines S₁ to Sₙ. The data lines are connected to the demultiplexers such that each demultiplexer is connected to a total of three data lines, i.e., one from each of the groups Dᵣ₁ to Dᵣₘ, D_{g1} to D_{gm}, and D_{b1} to D_{bm}. The n scanning lines S₁ to Sₙ are connected to the scanning line driver 50. The n emission lines E₁ to Eₙ are connected to the emission line driver 60.

The display device according to the present embodiment performs color display in the three primary colors, R, G, and B, and employs an SSD method, and therefore, the data line driver 30 supplies R, G, and B data signals to data output lines d₁ to dₘ in a time division manner, as in the display device shown in FIG. 1.

The demultiplexing portion 40 includes m demultiplexers 42₁ to 42ₘ. The demultiplexers have input terminals, each being connected to any one of the m data output lines d₁ to dₘ. Each demultiplexer has three output terminals, each being connected to three data lines. For example, the three output terminals of the demultiplexer 42₁ are respectively connected to the data lines Dᵣ₁, D_{g1}, and D_{b1}. The operation of the demultiplexer 42₁ is controlled by data control signals SSDᵣ, SSD_{g}, and SSD_{b}. The demultiplexer 42₁ is sequentially supplied with R, G, and B data signals, and supplies the R, G, and B data signals respectively to the data lines Dᵣ₁, D_{g1}, and D_{b1} from the three output terminals. Similarly, the demultiplexers 42₂ to 42ₘ are controlled by data control signals SSDᵣ, SSD_{g}, and SSD_{b}, sequentially supplied with R, G, and B data signals, and supply the R, G, and B data signals respectively to the data lines Dᵣ₂ to Dᵣₘ, the data lines D_{g2} to D_{gm}, and the data lines D_{b2} to D_{bm} from three respective output terminals.

It should be noted that the scanning line driver 50 and the emission line driver 60 are the same as those described in the first embodiment, and therefore, any descriptions thereof will be omitted.

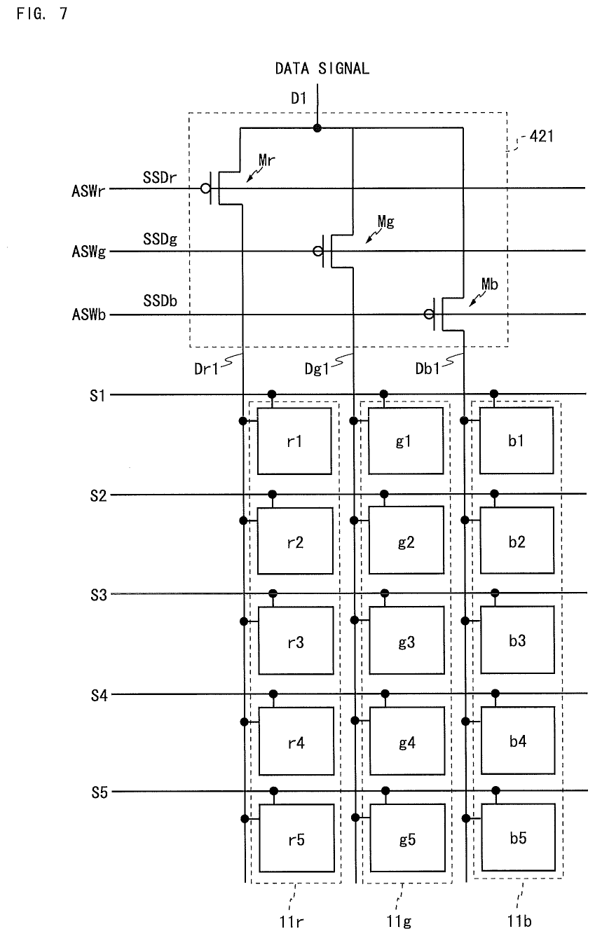

FIG. 7 is a circuit diagram illustrating the connection relationship between the demultiplexer 42₁ included in the demultiplexing portion of the display device shown in FIG. 6 and pixels r₁ to r₅, g₁ to g₅, and b₁ to b₅ connected to the demultiplexer 42₁. Note that in FIG. 7, as for the five pixel circuits 11ᵣ, the pixel circuits 11, connected to the first-row, second-row, third-row, fourth-row, and fifth-row scanning lines S₁, S₂, S₃, S₄, and S₅ are respectively shown as the pixels r₁, r₂, r₃, r₄, and r₅, as in FIG. 2. Similarly, the pixel circuits 11_{g} and 11_{b} are respectively shown as the pixels g₁ to g₅ and the pixels b₁ to b₅.

As shown in FIG. 7, the demultiplexer 42₁ includes selection transistors Mᵣ, M_{g}, and M_{b}. The selection transistor Mᵣ has a gate terminal connected to a data control line ASWᵣ, the selection transistor M_{g} has a gate terminal connected to a data control line ASW_{g}, and the selection transistor M_{b} has a gate terminal connected to a data control line ASW_{b}. Accordingly, the selection transistor Mᵣ is rendered in ON state when the gate terminal of the selection transistor Mᵣ is provided with a low-level data control signal SSDᵣ. The selection transistor M_{g} is rendered in ON state when the gate terminal of the selection transistor M_{g} is provided with a low-level data control signal SSD_{g}. The selection transistor M_{b} is rendered in ON state when the gate terminal of the selection transistor M_{b} is provided with a low-level data control signal SSD_{b}. Once the selection transistor Mᵣ is rendered in ON state, the data output line d₁ and the data line Dᵣ₁ are connected via the selection transistor Mᵣ. Once the selection transistor M_{g} is rendered in ON state, the data output line d₁ and the data line D_{g1} are connected via the selection transistor M_{g}. Once the selection transistor M_{b} is rendered in ON state, the data output line di and the data line D_{b1} are connected via the selection transistor M_{b}. The data line Dᵣ₁ is connected to the pixels r₁ to r₅, the data line D_{g1} is connected to the pixels g₁ to g₅, the data line D_{b1} is connected to the pixels b₁ to b₅, and the pixels r₁ to r₅, g₁ to g₅, and b₁ to b₅ are disposed in a matrix. Moreover, the pixels r₁ to r₅, g₁ to g₅, and b₁ to b₅ are connected to any of the scanning lines S₁ to S₅.

It should be noted that for the sake of convenience, the number of each of the R, G, and B pixels respectively connected to the R, G, and B data lines has been described as five. However, in actuality, n R pixels, n G pixels, and n B pixels are connected to the respective lines, as shown in FIG. 6.

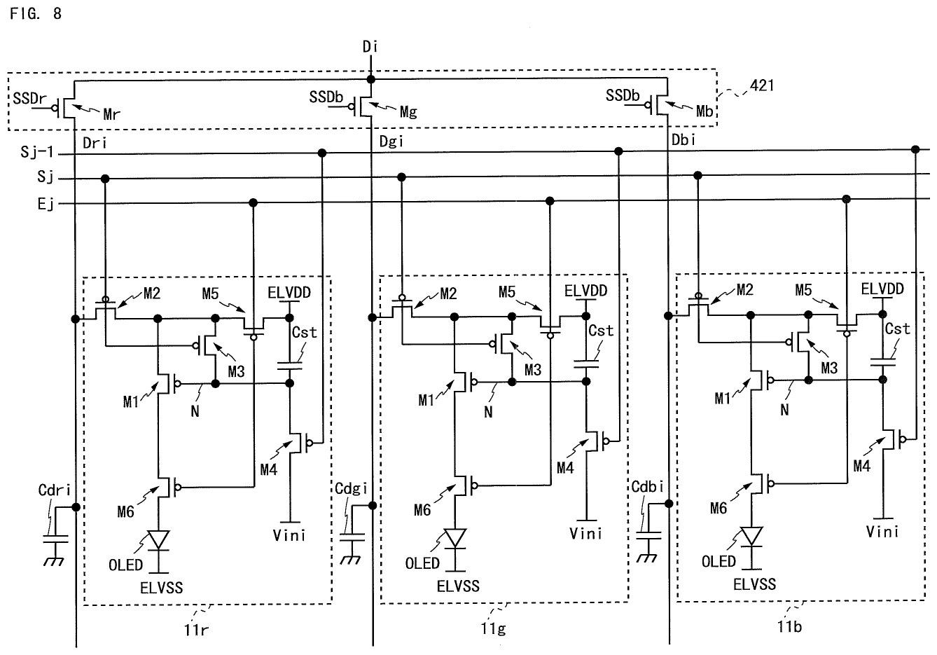

Next, the configuration of the pixel circuit 11 will be described. FIG. 8 is a circuit diagram illustrating the configuration of the pixel circuits 11ᵣ, 11_{g}, and 11_{b} included in the display device shown in FIG. 6 that are connected to the demultiplexer 42₁. As shown in FIG. 8, the pixel circuits 11ᵣ, 11_{g}, and 11_{b} are disposed in this order in a direction in which the current scanning line Sⱼ extends. Note that the configuration and the operation of the pixel circuits 11ᵣ, 11_{g}, and 11_{b} are basically the same as the configuration and the operation of the pixel circuits 11ᵣ and 11_{g} shown in FIG. 3. Therefore, any descriptions of the configuration and the operation of the pixel circuits 11ᵣ. 11_{g}, and 11_{b} shown in FIG. 8 will be omitted.

<2.1 Drive Method>

A drive method in which data signals are written to the pixel circuits 11 of the display device will be described with respect to the case where R, G, and B data signals are respectively written to the pixels r₁ to r₅, g₁ to g₅, and b₁ to b₅ respectively connected to the data lines Dᵣ₁, D_{g1}, and D_{b1} extending from the demultiplexer 42₁ shown in FIG. 7.

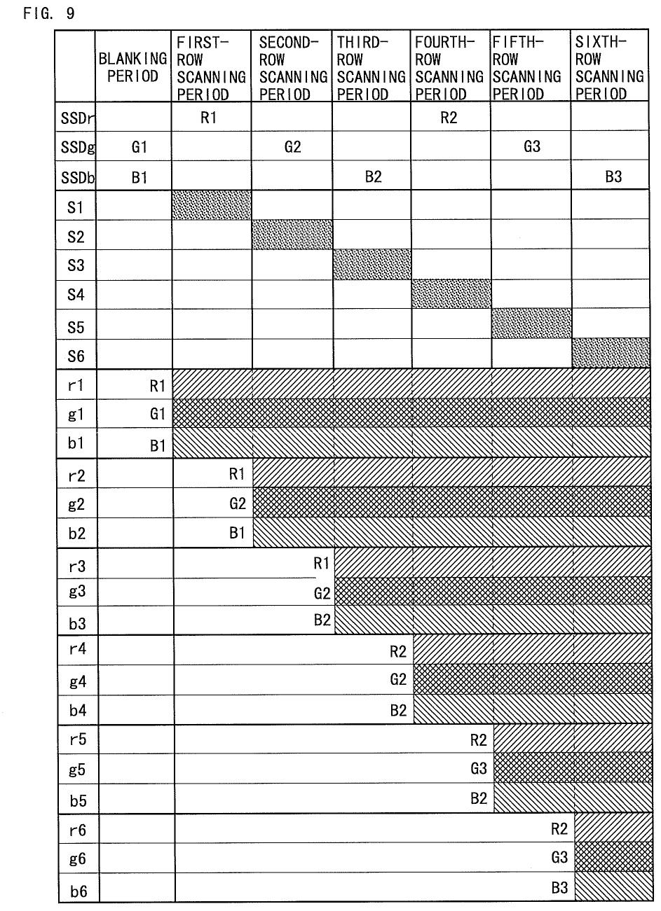

FIG. 9 is a timing chart describing the drive method in which R, G, and B data signals are respectively written to the pixels r₁ to r₅, g₁ to g₅, and b₁ to b₅ respectively connected to the data lines Dᵣ₁, D_{g1}, and D_{b1} in the circuit diagram shown in FIG. 7.

The data output line d₁ connected to the demultiplexer 42₁ is provided with a data signal D₁ consisting of R, G, and B data signals. Initially, during a first half of a blanking period, the data control line ASW_{g} is provided with a low-level data control signal SSD_{g}. As a result, the selection transistor M_{g} of the demultiplexer 42₁ is rendered in ON state, with the result that the data line D_{g1} is supplied with a data signal G₁ from the data output line d₁. Next, during a second half of the blanking period, the data control line ASW_{b} is provided with a low-level data control signal SSD_{b}. As a result, the selection transistor M_{b} is rendered in ON state, with the result that the data line D_{b1} is supplied with a data signal B₁ from the data output line d₁.

Next, during a first-row scanning period, a data control signal SSDᵣ is set to low level, with the result that the data line Dᵣ₁ is supplied with a data signal R₁ from the data output line d₁. Moreover, at the start of the first-row scanning period, the scanning line S₁ is selected. Accordingly, the data signal R₁ supplied to the data line Dᵣ₁ is written to the pixel r₁, the data signal G₁ supplied to the data line D_{g1} is written to the pixel g₁, and the data signal B₁ supplied to the data line D_{b1} is written to the pixel b₁. In this case, the data signal R₁ is the signal supplied to the data line Dᵣ₁ during the first-row scanning period. However, the signals that are used as the data signals G₁ and B₁ are the signals respectively supplied to the data lines D_{g1} and D_{b1} during the immediately preceding blanking period.

Next, during a second-row scanning period, the data control signal SSD_{g} is set to low level, with the result that the data line D_{g1} is supplied with a data signal G₂ from the data output line d₁. Moreover, at the start of the second-row scanning period, the scanning line S₂ is selected. Accordingly, the data signal R₁ supplied to the data line Dᵣ₁ is written to the pixel r₂, the data signal G₂ supplied to the data line D_{g1} is written to the pixel g₂, and the data signal B₁ supplied to the data line D_{b1} is written to the pixel b₂. In this case, the data signal G₂ is the signal supplied to the data line D_{g1} during the second-row scanning period. However, the signal that is used as the data signal R₁ is the signal supplied to the data line Dᵣ₁ during the first-row scanning period, and the signal that is used as the data signal B₁ is the signal supplied to the data line D_{b1} during the blanking period.

Next, during a third-row scanning period, the data control signal SSD_{b} is set to low level, with the result that the data line D_{b1} is supplied with a data signal B₂ from the data output line d₁. Moreover, at the start of the third-row scanning period, the scanning line S₃ is selected. Accordingly, the data signal B₂ supplied to the data line D_{b1} is written to the pixel b₃, the data signal G₂ supplied to the data line D_{g1} is written to the pixel g₃, and the data signal B₂ supplied to the data line D_{b1} is written to the pixel b₃. In this case, the data signal B₂ is the signal supplied to the data line D_{b1} during the third-row scanning period. However, the signal that is used as the data signal R₁ is the signal supplied to the data line Dᵣ₁ during the first-row scanning period, and the signal that is used as the data signal B₂ is the signal supplied to the data line D_{b1} during the second-row scanning period.

Thereafter, similarly, during a fourth-row scanning period, the data signal R₂ supplied to the data line Dᵣ₁ is written to the pixel r₄, the data signal G₂ supplied to the data line D_{g1} is written to the pixel g₄, and the data signal B₂ supplied to the data line D_{b1} is written to the pixel b₄. During a fifth-row scanning period, the data signal R₂ supplied to the data line Dᵣ₁ is written to the pixel r₅, a data signal G₃ supplied to the data line D_{g1} is written to the pixel gg, and the data signal B₂ supplied to the data line D_{b1} is written to the pixel b₅. During a sixth-row scanning period, the data signal R₂ supplied to the data line Dᵣ₁ is written to the pixel r₆, the data signal G₃ supplied to the data line D_{g1} is written to the pixel b₆, and a data signal B₃ supplied to the data line D_{b1} is written to the pixel b₆.

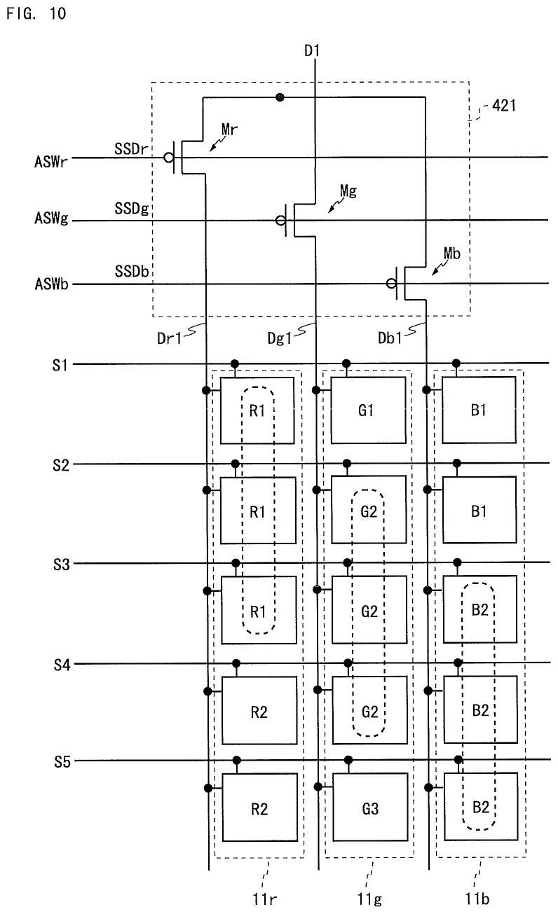

FIG. 10 is a diagram showing data signals written to pixels connected to the demultiplexer 42₁ in accordance with the drive method described in FIG. 9. As shown in FIG. 10, data signals, in order from the scanning line S₁ side: R₁, R₁, R₁, R₂, and R₂, are sequentially written to five R pixels connected to the data line Dᵣ₁, data signals, in the order: G₁, G₂, G₂, G₂, and G₃, are sequentially written to five G pixels connected to the data line D_{g1}, and data signals, in the order: B₁, B₁, B₂, B₂, and B₂, are sequentially written to five pixels connected to the data line D_{b1}. As a result, as for the R pixels, the data signal R₁ is written to three consecutive (first through third) pixels. As for the G pixels, the same data signal G₂ is written to three consecutive (second through fourth) pixels. As for the B pixels, the same data signal B₂ is written to three (third through fifth) pixels.

Thereafter, similarly, for each of the R, G, and B pixels, the same data signal is written to three consecutive pixels. Note that in FIG. 10 also, the consecutively written data signals are enclosed by dotted lines.

<2.3 Effects>

In the present embodiment, the data signal that is supplied from the data output line d₁ during one scanning period is any one of the R, G, and B data signals, and the remaining two data signals are not supplied. Accordingly, the data signals that are not supplied during that one scanning period are supplied during a preceding scanning period and held in data capacitors, and the data signals that are being held are utilized and simultaneously written to respectively corresponding pixels. In this case, using the two data signals supplied during the preceding scanning period eliminates the need for time to supply the two data signals during the one scanning period and therefore saves time correspondingly. Accordingly, it is possible to ensure sufficient time for writing the R, G, and B data signals respectively to the R, G, and B pixels during the one scanning period, thereby eliminating the risk of the data signals not being written correctly due to the shortage of writing time. Thus, even in the case of a display device with a number of pixels, data signals can be written correctly to all pixels, and therefore, the display device can display a high-definition image.

### 3. Third Embodiment

A display device according to a third embodiment will be described. The configuration of the display device according to the present embodiment, the connection relationship between the demultiplexer 42₁ and the pixels r₁ to r₅, g₁ to g₅, and b₁ to b₅, and the configuration of the pixel circuits 11ᵣ to 11_{b} are the same as in the second embodiment, and therefore, any figures and descriptions thereof will be omitted.

In the method in the second embodiment, each demultiplexer selects one of the three selection transistors for each scanning period and writes a data signal supplied to the data output line d₁ to a data line via the selected selection transistor, and signals supplied during a preceding scanning period and being held in data capacitors are utilized as two other data signals. However, in a drive method in the present embodiment, two of the three selection transistors are sequentially rendered in ON state for each scanning period, two data signals supplied via the two selection transistors in ON state are written to two respectively corresponding data lines, and a data signal supplied during a preceding scanning period and being held in a data capacitor is utilized as the remaining one data signal. Accordingly, the drive method in the present embodiment will be described in detail below.

<3.1 Drive Method>

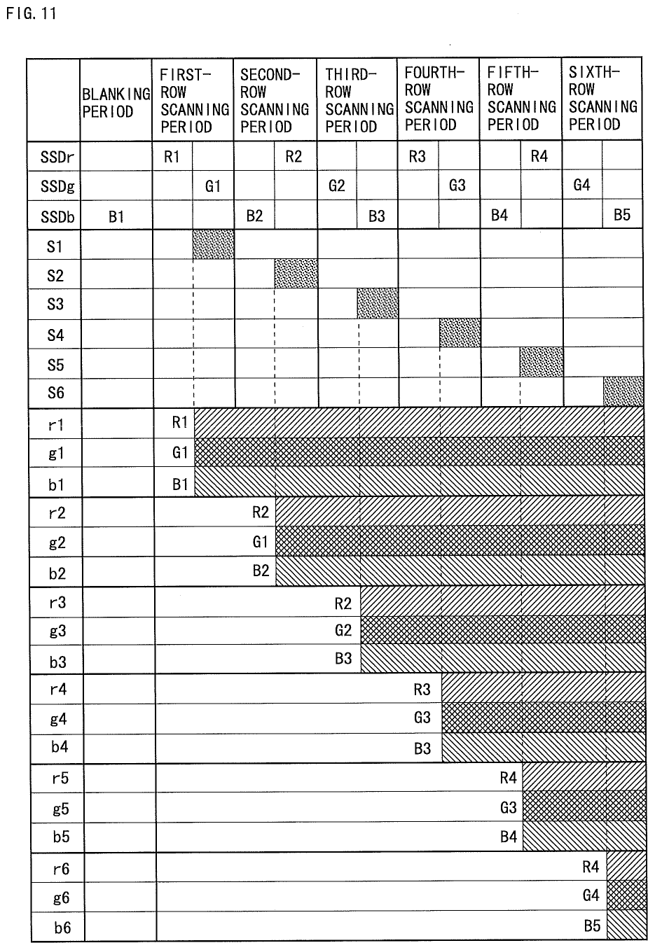

FIG. 11 is a timing chart describing a method in which R, G, and B data signals are respectively written to the pixels r₁ to r₆, g₁ to g₆, and b₁ to b₆ respectively connected to the data lines Dᵣ₁, D_{g1}, and D_{b1} in the display device according to the third embodiment.

As shown in FIG. 11ᵣ during a blanking period, the gate terminal of the selection transistor M_{b} is provided with a low-level data control signal SSD_{b}, with the result that the selection transistor M_{b} is rendered in ON state. In this case, the gate terminals of the selection transistors Mᵣ and M_{g} are respectively provided with high-level data control signals SSDᵣ and SSD_{g}, with the result that the selection transistors Mᵣ and M_{g} are rendered in OFF state. As a result, the data line D_{b1} is supplied with a data signal B₁ from the data output line di and held in the data capacitor Cd_{b1}.

During a first half of a first-row scanning period, the data output line d₁ is provided with a data signal R₁. Moreover, the data control line ASWᵣ is provided with a low-level data control signal SSDᵣ. As a result, the selection transistor Mᵣ is rendered in ON state, with the result that the data signal R₁ is supplied from the data output line d₁ to the data line Dᵣ₁. During a second half, the data output line d₁ is provided with a data signal G₁. Moreover, the data control line ASW_{g} is provided with a low-level data control signal SSD_{g}. Accordingly, the selection transistor M_{g} is rendered in ON state, with the result that the data signal G₁ is supplied from the data output line d₁ to the data line D_{g1}.

When the scanning line S₁ is selected at the start of the second half, the data signal R₁ supplied to the data line Dᵣ₁ is written to the pixel r₁, the data signal B₁ supplied to the data line D_{b1} is written to the pixel g₁, and the data signal B₁ supplied to the data line D_{b1} is written to the pixel b₁. In this case, the data signals R₁ and G₁ to be respectively written to the pixels r₁ and b₁ are the signals respectively supplied to the data lines Dᵣ₁ and D_{g1} during the first-row scanning period. However, the signal that is used as the data signal B₁ to be written to the pixel b₁ is the signal supplied to the data line D_{b1} during the immediately preceding blanking period.

During a first half of a second-row scanning period, the data output line d₁ is provided with a data signal B₂. Moreover, the data control line ASW_{b} is provided with a low-level data control signal SSD_{b}. Accordingly, the selection transistor M_{b} is rendered in ON state, with the result that the data signal B₂ is supplied from the data output line d₁ to the data line D_{b1}. During a second half, the data output line d₁ is provided with a data signal R₂. Moreover, the data control line ASWᵣ is provided with a low-level data control signal SSDᵣ. Accordingly, the selection transistor Mᵣ is rendered in ON state, with the result that the data signal R₂ is supplied from the data output line d₁ to the data line Dᵣ₁.

When the scanning line S₂ is selected at the start of the second half, the data signal R₂ supplied to the data line Dᵣ₁ is written to the pixel r₂, the data signal B₂ supplied to the data line D_{b1} is written to the pixel b₂, and the data signal G₁ supplied to the data line D_{g1} is written to the pixel g₂. In this case, the data signals R₂ and B₂ to be respectively written to the pixels r₂ and b₂ are the signals respectively supplied to the data lines Dᵣ₁ and D_{g1} during the second-row scanning period. However, the signal that is used as the data signal G₁ to be written to the pixel g₂ is the signal supplied to the data line D_{g1} during the first-row scanning period.

During a first half of a third-row scanning period, the data output line d₁ is provided with a data signal G₂. Moreover, the data control line ASW_{g} is provided with a low-level data control signal SSD_{g}. Accordingly, the selection transistor M_{g} is rendered in ON state, with the result that the data signal G₂ is supplied from the data output line d₁ to the data line D_{g1}. During a second half, the data output line d₁ is provided with a data signal B₃. Moreover, the data control line ASW_{b} is provided with a low-level data control signal SSD_{b}. Accordingly, the selection transistor M_{b} is rendered in ON state, with the result that the data signal B₂ is supplied from the data output line d₁ to the data line D_{b1}.

When the scanning line S₃ is selected at the start of the second half, the data signal G₂ supplied to the data line D_{g1} is written to the pixel g3, the data signal B₃ supplied to the data line D_{b1} is written to the pixel b₃, and the data signal R₂ supplied to the data line Dᵣ₁ is written to the pixel r₃. In this case, the data signals G₂ and B₃ to be respectively written to the pixels g₃ and b₃ are the signals supplied to the data lines D_{g1} and D_{b1} during the third-row scanning period. However, the signal that is used as the data signal R₂ to be written to the pixel r₃ is the signal supplied to the data line Dᵣ₁ during the second-row scanning period.

Thereafter, similarly, during a fourth-row scanning period, data signals R_{3,} G₃, and B₃ are respectively written to the pixels r₄, g₄, and b₄. During a fifth-row scanning period, a data signal R₄ is written to the pixel r₅, the data signal G₃ is written to the pixel g₅, and a data signal B₄ is written to the pixel b₅. During a sixth-row scanning period, the data signal R₄ is written to the pixel r₆, a data signal G₄ is written to the pixel g₆, and a data signal B₅ is written to the pixel b₆.

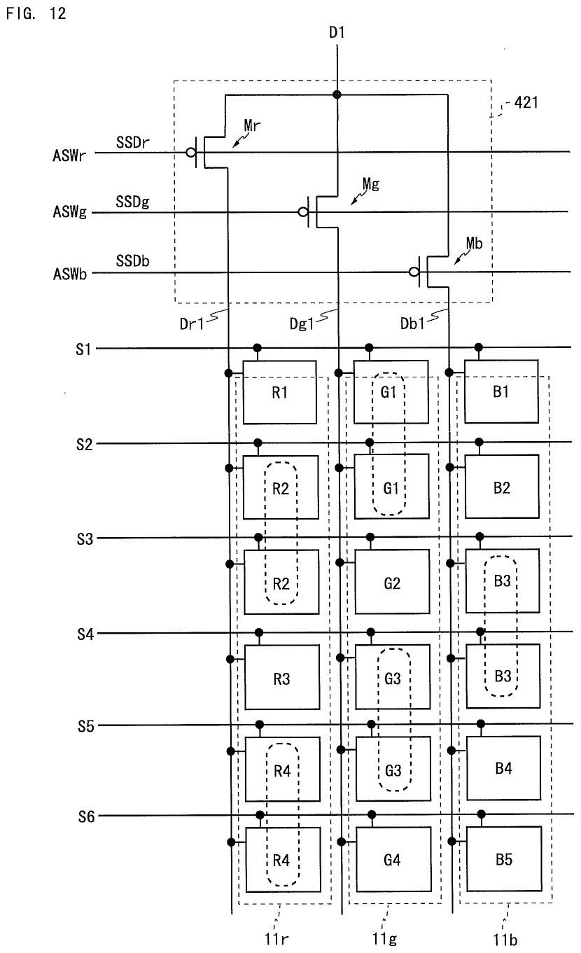

FIG. 12 is a diagram showing data signals written to pixels connected to the demultiplexer 42₁ in accordance with the drive method described in FIG. 11. As shown in FIG. 12, data signals, in order from the scanning line S₁ side: R₁, R₂, R₂, R₃, R₄, and R₄, are sequentially written to six R pixels connected to the data line Dᵣ₁, data signals, in the order: G₁, G₁, G₂, G₃, G₃, and G₄, are sequentially written to six G pixels connected to the data line D_{g1}, and data signals, in the order: B₁, B₂, B₃, B₃, B₄, and B₅ are sequentially written to five pixels connected to the data line D_{b1}. As a result, as for the R pixels, the same data signal R₂ is written to second and third pixels, and the same data signal R₄ is written to fifth and sixth pixels. As for the G pixels, the same data signal G₁ is written to first and second pixels, and the same data signal G₃ is written to fourth and fifth pixels. As for the B pixels, the same data signal B₃ is written to third and fourth pixels. Thereafter, similarly, the same R data signal is written to two consecutive pixels from a pixel r8 onward. The same G data signal is written to two consecutive pixels from a pixel g₇ onward. The same B data signal is written to two consecutive pixels from a pixel b₆ onward. Note that in FIG. 12 also, the consecutively written data signals are enclosed by dotted lines.

<3.2 Effects>

In the present embodiment, the data signals to be supplied from the data output line d₁ during one scanning period are any two of the R, G, and B data signals, and the remaining one data signal is not supplied. Accordingly, the data signal that is not supplied during that one scanning period is supplied during a preceding scanning period and held in a data capacitor, and such data signals that are being held are utilized and simultaneously written to corresponding pixels. In this case, the need for time to supply the remaining one data signal during the one scanning period is eliminated, and therefore, time can be saved correspondingly. Accordingly, it is possible to ensure sufficient time for writing the R, G, and B data signals respectively to the R, G, and B pixels during the one scanning period, thereby eliminating the risk of the data signals not being written correctly due to the shortage of writing time. Thus, even in the case of a display device with a number of pixels, data signals can be written correctly to all pixels, and therefore, the display device can display a high-definition image.

### 4. Fourth Embodiment

A display device according to a fourth embodiment will be described. The configuration of the display device according to the present embodiment and the configuration of the pixel circuits 11ᵣ to 11_{b} are the same as in the second and third embodiments, and therefore, any figures and descriptions thereof will be omitted. However, the configuration of the demultiplexer differs from those in the second and third embodiments. Therefore, the configuration of the demultiplexer will be described below along with a drive method.

FIG. 13 is a circuit diagram illustrating the connection relationship between a demultiplexer 43₁ and pixels r₁ to r5, g₁ to g₅, and b₁ to b₅ connected to the demultiplexer 43₁ in the present embodiment. As shown in FIG. 13, the demultiplexer includes selection transistors Mᵣ and Mb, but unlike the demultiplexer 42₁ shown in FIG. 7, no selection transistor M_{g} is included. The selection transistor Mᵣ has a gate terminal connected to the data control line ASWᵣ, and the selection transistor M_{b} has a gate terminal connected to the data control line ASW_{b}. Accordingly, when the gate terminal of the selection transistor Mᵣ is provided with a low-level data control signal SSDᵣ, the selection transistor Mᵣ is rendered in ON state, with the result that the data output line d₁ and the data line Dᵣ₁ are connected. Moreover, when the gate terminal of the selection transistor M_{b} is provided with a low-level data control signal SSD_{b}, the selection transistor M_{b} is rendered in ON state, with the result that the data output line d₁ and the data line D_{b1} are connected. Moreover, the data line driver 30 provides a data signal including data signals R₁ and B₁ multiplexed in a time division manner, the data signal R₁ is outputted to the data line Dᵣ₁ when the selection transistor Mᵣ is in ON state, and the data signal B₁ is outputted to the data line D_{b1} when the selection transistor M_{b} is in ON state.

However, since no selection transistor M_{g} is provided, the data line D_{g1} is directly connected to a terminal of the data line driver 30 from which a data signal G₁ is outputted. Accordingly, whenever the data output line d₁ is provided with a G data signal, the G data signal is written to the data line D_{g1}, and moreover, it is preferred that the data signals G₁ that are written to the pixels g₁ to g₅ connected to the scanning lines provided with low-level scanning signals vary every scanning period, but the same data signal G₁ may be consecutively written to pixels whose scanning periods differ from each other.

<4.1 Drive Method>

A drive method in which data signals are written to the pixel circuits 11 of the display device will be described with respect to the case where R, G, and B data signals are respectively written to the pixels r₁ to r₅, g₁ to g₅, and b₁ to b₅ respectively connected to the data lines Dᵣ₁, D_{g1}, and D_{b1} extending from the demultiplexer 43₁ shown in FIG. 13.

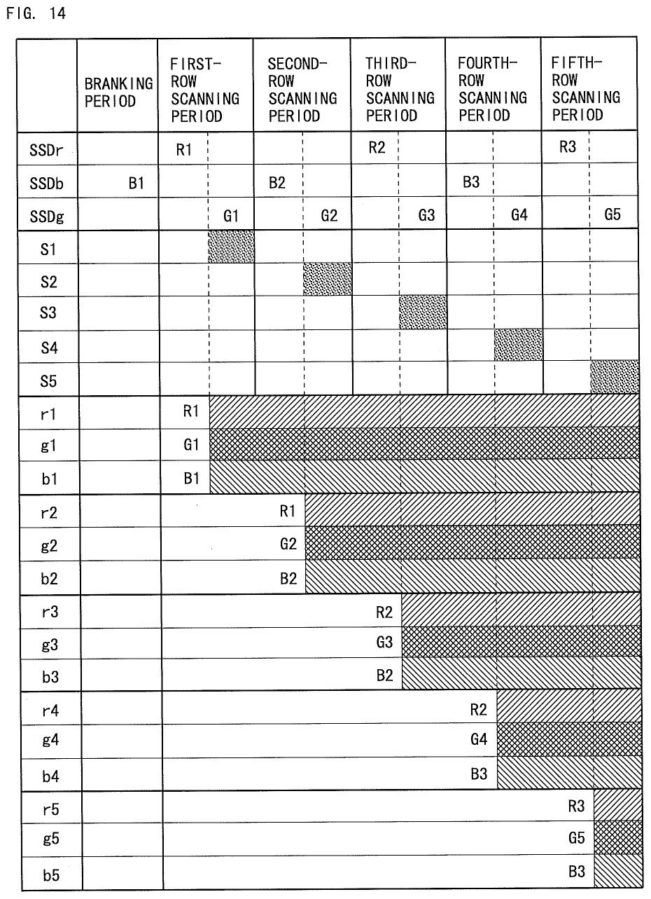

FIG. 14 is a timing chart describing the drive method in which R, G, and B data signals are respectively written to the pixels r₁ to r₅, g₁ to g₅, and b₁ to b₅ respectively connected to the data lines Dᵣ₁, D_{g1}, and D_{b1} in the display device shown in FIG. 13.

The data output line d₁ connected to the demultiplexer 43₁ is provided with a data signal D₁ consisting of R, G, and B data signals. Initially, during a blanking period, the data control line ASW_{b} is provided with a low-level data control signal SSD_{b}. Accordingly, the selection transistor M_{b} of the demultiplexer 43₁ is rendered in ON state, with the result that the data line D_{b1} is supplied with a data signal B₁ from the data output line d₁.

Next, during a first half of a first-row scanning period, a data control signal SSDᵣ is set to low level, with the result that the data line Dᵣ₁ is supplied with a data signal R₁ from the data output line d₁. During a second half, the data line D_{g1} is supplied with a data signal G₁ from the data output line d₁. Moreover, at the start of the second half, the scanning line S₁ is selected. Accordingly, the data signal R₁ supplied to the data line Dᵣ₁ is written to the pixel r₁, the data signal G₁ supplied to the data line D_{g1} is written to the pixel g₁, and the data signal B₁ supplied to the data line D_{b1} is written to the pixel b₁. In this case, the data signals R₁ and G₁ are the signals supplied to the data lines Dᵣ₁ and D_{g1} during the first-row scanning period. However, the signal that is used as the data signal B₁ is the signal supplied to the data line D_{b1} during the immediately preceding blanking period.

Next, during a first half of a second-row scanning period, the data control signal SSD_{b} is set to low level, with the result that the data line D_{b1} is supplied with a data signal B₂ from the data output line d₁. During a second half, the data line D_{g1} is supplied with a data signal G₂ from the data output line d₁. Moreover, at the start of the second half, the scanning line S₂ is selected. Accordingly, the data signal B₂ supplied to the data line D_{b1} is written to the pixel b₂, the data signal G₂ supplied to the data line D_{g1} is written to the pixel g₂, and the data signal R₁ supplied to the data line Dᵣ₁ is written to the pixel r₂. In this case, the data signals B₂ and G₂ are the signals respectively supplied to the data lines D_{b1} and D_{g1} during the second-row scanning period. However, the signal that is used as the data signal R₁ is the signal supplied to the data line Dᵣ₁ during the first-row scanning period.

Next, during a first half of a third-row scanning period, the data control signal SSDᵣ is set to low level, with the result that the data line Dᵣ₁ is supplied with a data signal R₂ from the data output line d₁. During a second half, the data line D_{g1} is supplied with a data signal G₃ from the data output line d₁. Moreover, at the start of the second half, the scanning line S₃ is selected. Accordingly, the data signal R₂ supplied to the data line Dᵣ₁ is written to the pixel r₃, the data signal G₃ supplied to the data line D_{g1} is written to the pixel g₃, and the data signal B₂ supplied to the data line D_{b1} is written to the pixel b₃. In this case, the data signals R₂ and G₃ are the signals respectively supplied to the data lines D_{b1} and D_{g1} during the third-row scanning period. However, the signal that is used as the data signal B₂ is the signal supplied to the data line D_{b1} during the second-row scanning period.

Thereafter, similarly, during a fourth-row scanning period, a data signal R₂ supplied to the data line Dᵣ₁ is written to the pixel r₄, a data signal G₄ supplied to the data line D_{g1} is written to the pixel g₄, and the data signal B₃supplied to the data line D_{b1} is written to the pixel b₄. During a fifth-row scanning period, a data signal R₃ supplied to the data line Dᵣ₁ is written to the pixel r₅, a data signal G₅ supplied to the data line D_{g1} is written to the pixel g₅, and the data signal B₃ supplied to the data line D_{b1} is written to the pixel b₅.

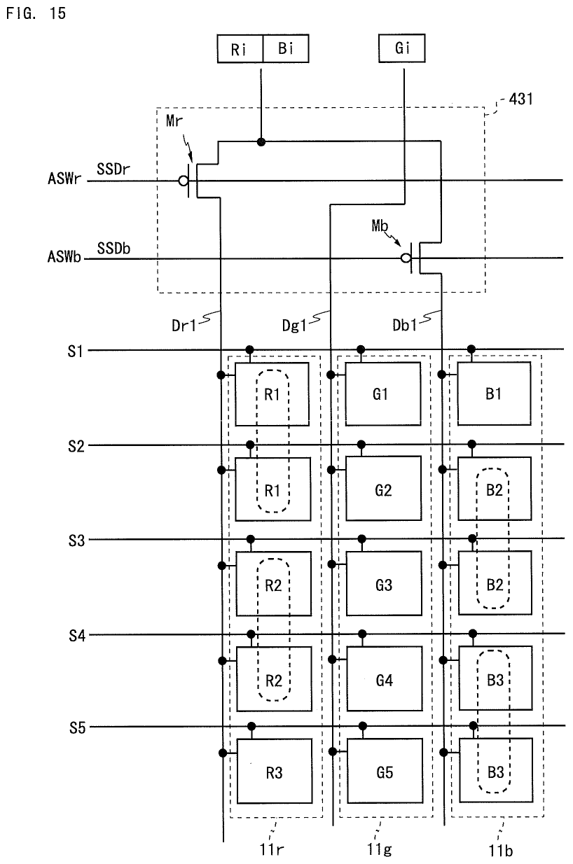

FIG. 15 is a diagram showing data signals written to pixels connected to the demultiplexer 43₁ in accordance with the drive method shown in FIG. 14. As shown in FIG. 15, data signals, in order from the scanning line S₁ side: R₁, R₁, R₂, R₂, and R₃ are sequentially written to five R pixels connected to the data line Dᵣ₁, data signals, in the order: G₁, G₂, G₃, G₄, and G₅, are sequentially written to five G pixels connected to the data line D_{g1}, and data signals, in the order: B₁, B₂, B₂, B₃, and B₃ are sequentially written to five pixels connected to the data line D_{b1}. As a result, as for the R pixels, the data signal R₁ is written to first and second pixels, and the data signal R₂ is written to third and fourth pixels. As for the B pixels, the data signal B₂ is written to second and third pixels, and the data signal B₃ is written to fourth and fifth pixels. However, the data line D_{g1} is supplied only with G data signals. Accordingly, different G data signals can be written to respective G pixels. Note that in FIG. 15 also, the consecutively written data signals are enclosed by dotted lines.

<4.2 Effects>

In the present embodiment, of the data signals that are supplied from the data output line d₁ during each scanning period, the R and B data signals are alternatingly outputted to the respective data lines Dᵣ₁ and D_{b1} every scanning period, as in the other embodiments. On the other hand, the G data signal is outputted to the data line D_{g1} during each scanning period. The G data signal is a signal which significantly affects image definition, and therefore, by the data line driver 30 outputting the G data signal during each scanning period, as in the embodiment, it is rendered possible to display a high-definition color image. Moreover, by changing the G data signal for each scanning period, a higher-definition color image can be displayed. Other effects are the same as those described in the other embodiments, and therefore, any descriptions thereof will be omitted.

<5. Other>

The display of the present embodiment is not limited to display panels with organic EL elements OLED, and any display panels with electro-optical elements may be employed so long as the luminance and/or the transmittance of the electro-optical elements are controlled by current. Examples of displays with such current-controlled electro-optical elements include EL displays, such as organic EL displays with organic light-emitting diodes (OLEDs) and inorganic EL displays with inorganic light-emitting diodes, and QLED displays with quantum-dot light-emitting diodes.

<6. Appendix>

Appendix 1 is directed to an active-matrix display device for displaying a color image based on a plurality of colors by supplying pixel circuits with a plurality of data signals in a time division manner, the data signals respectively corresponding to the colors, the display device including a plurality of data lines to be supplied with data signals, a plurality of scanning lines to be sequentially supplied with scanning signals for selecting the pixel circuits, a plurality of pixel circuits provided corresponding to the data lines and the scanning lines, each pixel circuit corresponding to any one of the colors, a scanning line driver circuit configured to sequentially select the scanning lines, a plurality of select/output circuits configured to sequentially supply the data signals to the data lines, each data signal corresponding to any one of the colors, and a data line driver circuit configured to supply the data signals respectively to the select/output circuits, each of the pixel circuits corresponding to the colors includes an electro-optical element, a drive transistor configured to control a current flowing through the electro-optical element and having a control terminal and a first conductive terminal electrically connected to each other when the scanning line is being selected, and a capacitive storage element configured to hold a potential applied at a node connecting the control terminal and the first conductive terminal of the drive transistor, wherein the select/output circuit supplies the data lines with respectively corresponding data signals representing at least one of the colors, and the scanning line driver circuit sequentially drives the scanning lines and thereby supplies data signals to the nodes provided in the pixel circuits corresponding to the colors represented by the data signals, with the result that potentials applied at the nodes are held in the capacitive storage elements, the data signals including the data signals representing the at least one of the colors and data signals previously supplied to the data lines and representing a color not represented by the data signals representing the at least one of the colors.

In Appendix 2 directed to a display device based on the display device of Appendix 1, a data signal that is used as a data signal to be provided to the pixel circuit, but not by the select/output circuit, during at least a first horizontal period within each frame period may be a data signal supplied to the data line by the select/output circuit and held in the capacitive element connected to the data line during a blanking period in a transition to the frame period from an immediately preceding frame period.

In the display device of Appendix 2, the data signal not provided by the select/output circuit during the horizontal period is supplied to the data line by the select/output circuit and held in the capacitive element connected to the data line during the blanking period in the transition to the frame period from the immediately preceding frame period. Accordingly, when data signals are written to pixel circuits, data signals held in capacitive elements during the blanking period can be used, and therefore, during the first horizontal period within each frame period, the time for supplying the data signals to the data lines can be reduced correspondingly. Thus, it is possible to ensure sufficient time for writing data signals to corresponding pixel circuits, thereby eliminating the risk of the data signals not being written correctly due to the shortage of writing time.

In Appendix 3 directed to a display device based on the display device of Appendix 1, the select/output circuit may include two selection transistors configured to sequentially select data signals corresponding to two colors and supply the data signals respectively to two corresponding data lines, and the two selection transistors may output data signals selected from the data signals corresponding to the two colors to the corresponding data lines, in accordance with data control signals respectively provided through two data control lines connected to control terminals of the selection transistors.

In the display device of Appendix 3, the select/output circuit includes the two selection transistors respectively connected to two data lines, and the two selection transistors output data signals selected from data signals corresponding to two colors to corresponding data lines, in accordance with data control signals respectively provided through two data control lines. Accordingly, it is possible to ensure sufficient writing time for writing a data signal that corresponds to a color to a pixel circuit corresponding to that color and also a data signal that corresponds to another color to a pixel circuit corresponding to that color, thereby eliminating the risk of the data signals not being written correctly due to the shortage of writing time.

In Appendix 4 directed to a display device based on the display device of Appendix 1, the select/output circuit may include three selection transistors configured to sequentially select data signals corresponding to three colors and supply the data signals respectively to three corresponding data lines, and the three selection transistors may select one or two data signals from the data signals corresponding to the three colors and output the one or two data signals to the corresponding data lines, in accordance with data control signals respectively provided through three data control lines connected to control terminals of the selection transistors.

In the display device of Appendix 4, the select/output circuit includes three selection transistors which are respectively connected to three data lines, and the three selection transistors output any one data signal for each horizontal period. Accordingly, it is possible to ensure sufficient writing time for writing a data signal that corresponds to a color to a pixel circuit corresponding to that color and also a data signal that corresponds to another color to a pixel circuit corresponding to that color, thereby eliminating the risk of the data signals not being written correctly due to the shortage of writing time.

In Appendix 5 directed to a display device based on the display device of Appendix 1, the data signals for the colors may include a green data signal, and the green data signal may be written for each horizontal period to the capacitive storage element of the pixel circuit to which the green data signal should be written.

In the display device of Appendix 5, since the G data signal is a signal which significantly affects image definition, by the data line driver 30 outputting the G data signal during each scanning period, it is rendered possible to display a high-definition color image.

In Appendix 6 directed to a display device based on the display device of Appendix 5, the green data signal may be a data signal for displaying a different image for each horizontal period.

In the display device of Appendix 6, the green data signal is a data signal for displaying a different image for each horizontal period, whereby it is rendered possible to display a higher-definition color image.

In Appendix 7 directed to a display device based on the display device of Appendix 1, which may further include first and second power lines for supplying a power source potential in common to the pixel circuits, the electro-optical element may be provided between the first and second power lines, the drive transistor may be provided in series to the electro-optical element between the first and second power lines, and each of the pixel circuits corresponding to the colors may further include a writing transistor provided between a second conductive terminal of the drive transistor and the data line and having a control terminal connected to the scanning line, and a compensation transistor provided between the control terminal and the first conductive terminal of the drive transistor and having a control terminal connected to the scanning line.

The display device of Appendix 7 achieves effects similar to those achieved by the display device of Appendix 1 where the writing transistor writes a data voltage to the pixel circuit, and the compensation transistor is used to compensate for changes of a threshold voltage of the drive transistor.

Appendix 8 is directed to a display device based on the display device of Appendix 7, which may further include a plurality of control lines provided along the scanning lines, and a control line driver circuit configured to cause the electro-optical element in the pixel circuit connected to the scanning line to emit light upon completion of a selection period during which the scanning line is being selected.

The display device of Appendix 8 renders it possible to control the duration of light emission by the electro-optical element.

In Appendix 9 directed to a display device based on the display device of Appendix 8, the pixel circuit may further include a power supply transistor provided between the first conductive terminal of the drive transistor and the first power line and having a control terminal connected to the control line, and an emission control transistor provided between the second conductive terminal of the drive transistor and a terminal of the electro-optical element and having a control terminal connected to the control line, and upon completion of the selection period for the scanning line, the control line driver circuit may supply the control line with a potential by which each of the power supply transistor and the emission control transistor of the pixel circuit is rendered conductive.

The display device of Appendix 9 achieves effects similar to those achieved by the display device of Appendix 8, by using the power supply transistor and the emission control transistor.

In Appendix 10 directed to a display device based on the display device of Appendix 7, each of a plurality of pixel circuits arranged in a direction in which the scanning line extends may further include an initialization transistor provided between an initialization line for supplying an initialization potential and the control terminal of the drive transistor or a terminal of the capacitive storage element, the initialization transistor having a control terminal connected to a scanning line immediately preceding the scanning line for the pixel circuits.

In the display device of Appendix 10, the initialization transistor initializes the potential at the control terminal of the drive transistor. Thus, it is possible to reliably write the data voltage to the pixel circuit in accordance with the data signal.

### DESCRIPTION OF THE REFERENCE CHARACTERS

10 display portion

11 pixel circuit

20 display control circuit

30 data line driver (data line driver circuit)

40 demultiplexing portion

41₁ to 41ₘ, 42₁ to 42ₘ demultiplexer (select/output circuit)

50 scanning line driver (scanning line driver circuit)

60 emission line driver (control line driver circuit)

dᵢ (i is an integer from 1 to m) output line

Dᵣᵢ, D_{gi}, D_{bi} (i=an integer from 1 to m) data line

Sⱼ (j =an integer from 1 to n) scanning line

Eⱼ (j =an integer from 1 to n) emission line (control line)

M1 to M6, Mᵣ, M_{g}, M_{b} transistor

Cₛₜ storage capacitor (capacitive storage element)

Cdᵣᵢ, Cd_{gi}, Cd_{bi} (i is an integer from 1 to m) data capacitor (capacitive element)

ELVDD high-level power line (first power line)

ELVSS low-level power line (second power line)

Vᵢₙᵢ initialization line

1. An active-matrix display device for displaying a color image based on a plurality of colors by supplying pixel circuits with a plurality of data signals in a time division manner, the data signals respectively corresponding to the colors, the display device comprising:
a plurality of data lines to be supplied with data signals;
a plurality of scanning lines to be sequentially supplied with scanning signals for selecting the pixel circuits;
a plurality of pixel circuits provided corresponding to the data lines and the scanning lines, each pixel circuit corresponding to any one of the colors;
a scanning line driver circuit configured to sequentially select the scanning lines;
a plurality of select/output circuits configured to sequentially supply the data signals to the data lines, each data signal corresponding to any one of the colors; and
a data line driver circuit configured to supply the data signals respectively to the select/output circuits, wherein,
each of the pixel circuits corresponding to the colors includes:
an electro-optical element;
a drive transistor configured to control a current flowing through the electro-optical element and having a control terminal and a first conductive terminal electrically connected to each other when the scanning line is being selected; and
a capacitive storage element configured to hold a potential applied at a node connecting the control terminal and the first conductive terminal of the drive transistor,
the select/output circuit supplies the data lines with respectively corresponding data signals representing at least one of the colors, and
the scanning line driver circuit sequentially drives the scanning lines and thereby supplies data signals to the nodes provided in the pixel circuits corresponding to the colors represented by the data signals, with the result that potentials applied at the nodes are held in the capacitive storage elements, the data signals including the data signals representing the at least one of the colors and data signals previously supplied to the data lines and representing a color not represented by the data signals representing the at least one of the colors.

2. The display device according to claim 1, wherein a data signal that is used as a data signal to be provided to the pixel circuit, but not by the select/output circuit, during at least a first horizontal period within each frame period is a data signal supplied to the data line by the select/output circuit and held in the capacitive element connected to the data line during a blanking period in a transition to the frame period from an immediately preceding frame period.

3. The display device according to claim 1, wherein,
the select/output circuit includes two selection transistors configured to sequentially select data signals corresponding to two colors and supply the data signals respectively to two corresponding data lines, and
the two selection transistors output data signals selected from the data signals corresponding to the two colors to the corresponding data lines, in accordance with data control signals respectively provided through two data control lines connected to control terminals of the selection transistors.

4. The display device according to claim 1, wherein,
the select/output circuit includes three selection transistors configured to sequentially select data signals corresponding to three colors and supply the data signals respectively to three corresponding data lines, and
the three selection transistors select one or two data signals from the data signals corresponding to the three colors and output the one or two data signals to the corresponding data lines, in accordance with data control signals respectively provided through three data control lines connected to control terminals of the selection transistors.

5. The display device according to claim 1, wherein,
the data signals for the colors include a green data signal, and
the green data signal is written for each horizontal period to the capacitive storage element of the pixel circuit to which the green data signal should be written.

6. The display device according to claim 5, wherein the green data signal is a data signal for displaying a different image for each horizontal period.

7. The display device according to claim 1, further comprising first and second power lines for supplying a power source potential in common to the pixel circuits, wherein,
the electro-optical element is provided between the first and second power lines,
the drive transistor is provided in series to the electro-optical element between the first and second power lines, and
each of the pixel circuits corresponding to the colors further includes:
a writing transistor provided between a second conductive terminal of the drive transistor and the data line and having a control terminal connected to the scanning line; and
a compensation transistor provided between the control terminal and the first conductive terminal of the drive transistor and having a control terminal connected to the scanning line.

8. The display device according to claim 7, further comprising:
a plurality of control lines provided along the scanning lines; and
a control line driver circuit configured to cause the electro-optical element in the pixel circuit connected to the scanning line to emit light upon completion of a selection period during which the scanning line is being selected.

9. The display device according to claim 8, wherein,
the pixel circuit further includes:
a power supply transistor provided between the first conductive terminal of the drive transistor and the first power line and having a control terminal connected to the control line; and
an emission control transistor provided between the second conductive terminal of the drive transistor and a terminal of the electro-optical element and having a control terminal connected to the control line, and
upon completion of the selection period for the scanning line, the control line driver circuit supplies the control line with a potential by which each of the power supply transistor and the emission control transistor of the pixel circuit is rendered conductive.

10. The display device according to claim 7, wherein each of a plurality of pixel circuits arranged in a direction in which the scanning line extends further includes an initialization transistor provided between an initialization line for supplying an initialization potential and the control terminal of the drive transistor or a terminal of the capacitive storage element, the initialization transistor having a control terminal connected to a scanning line immediately preceding the scanning line for the pixel circuits.

11. A method for driving a display device providing color display based on a plurality of colors by supplying data signals to pixel circuits in a time division manner, each data signal corresponding to any one of the colors, wherein,
the display device includes a plurality of data lines to be supplied with data signals, a plurality of scanning lines, a plurality of pixel circuits provided corresponding to the data lines and the scanning lines, each pixel circuit corresponding to any one of the colors, and a plurality of select/output circuits configured to sequentially supply the data signals to the data lines, each data signal corresponding to any one of the colors,
each of the pixel circuits corresponding to the colors includes an electro-optical element, a drive transistor configured to control a current flowing through the electro-optical element and having a control terminal and a first conductive terminal electrically connected to each other when a corresponding scanning line is being selected, and a capacitive storage element configured to hold a potential applied at a node connecting the control terminal and the first conductive terminal of the drive transistor, and
the method comprises the steps of:
supplying the data lines with respectively corresponding data signals representing at least one of the colors;
sequentially driving the scanning lines and thereby supplying data signals to the nodes provided in the pixel circuits corresponding to the colors represented by the data signals, the data signals including the data signals representing the at least one of the colors and data signals previously supplied to the data lines and representing a color not represented by the data signals representing the at least one of the colors; and
causing the capacitive storage elements to hold the potentials applied at the nodes.
